(19) United States
(12) Patent Application Publication
(10) Pub. No.: US 2010/0198374 A1
(43) Pub. Date: Aug. 5, 2010

(54) METHOD AND SYSTEM FOR CONTROLLING ERGONOMIC SETTINGS AT A WORKSITE

(75) Inventors: Barry R. Carson, Highlands Ranch, CO (US); David R. Carson, Larkspur, CO (US)

Correspondence Address: SHERIDAN ROSS PC, 1560 BROADWAY, SUITE 1200, DENVER, CO, 80202, US

(73) Assignee: XYBIX Systems, Inc., Littleton, CO (US)

(21) Appl. No.: 12/761,916

(22) Filed: Apr. 16, 2010

Related U.S. Application Data
(63) Continuation of application No. 10/459,207, filed on Jun. 10, 2003.
(60) Provisional application No. 60/388,040, filed on Jun. 10, 2002.

(51) Int. Cl. G05B 15/02; G08B 5/22

(52) U.S. Cl. 700/90; 340/825.36

(57) ABSTRACT

An ergonomic control system is disclosed for monitoring and/or controlling ergonomic settings of one or more adjustable furniture units at a user's worksite. The furniture units may include, e.g., a table, a chair, a worksite lighting mechanism, a thermostat, computer monitor, and computer keyboard, and a phone. The control system is distributed over a network, with a central administration subsystem receiving ergonomic current setting data regarding adjustable furniture units from worksites in use. Such current setting data is associated with the current worksite user and stored for subsequent comparison with preferred ergonomic settings thereby to identify users whose settings may be detrimental to their health.

### CROSS REFERENCE TO RELATED APPLICATIONS

This application is a continuation of U.S. patent application Ser. No. 10/459,207 filed Jun. 10, 2003, which claims the benefit of U.S. Provisional Patent Application Ser. No. 60/388,040 filed Jun. 10, 2002. The entire disclosures of the prior applications hereinabove are incorporated herein fully by reference.

### FIELD OF THE INVENTION

The present invention is directed to a method and system for controlling ergonomic settings in the work place and in particular, is directed to a method and system for determining the correct ergonomic settings for office furniture, such as a table at which a worker sits, to ensure that the height of such table is appropriate for the particular person working thereon.

### BACKGROUND OF THE INVENTION

Office workplace injuries, such as carpal tunnel syndrome, muscle fatigue and back injuries, have dramatically increased over the past several years. New medical terminology for such injuries include Repetitive Motion Injury (RMI), Cumulative Trauma Disease (CTD) and Overuse Syndrome (OS) among others. It is widely accepted that such increase in workplace injuries is a result of information age workers being forced to work in a sedentary, constrained position for extended time periods performing highly repetitive tasks. Such injuries are further exacerbated by ergonomically improper working positions.

Costs of worker's compensation claims, lost time, retraining, job reassignment and permanent disability claims associated with such injuries have skyrocketed. Repetitive motion activities performed over an indeterminate period of time (i.e., many years for some operators, a few weeks or months for others) coupled with improper static working posture, inadequate breaks and/or poor working environment are believed to be the cause of nearly 50% of all RMI worker's compensation claims.

Attempts have been made to alleviate the above-noted problems. Many organizations, including the federal government, have instigated policies for reducing the amount of continuous time spent performing repetitive-type motions. For example, many workers are given frequent breaks (e.g., hourly) to allow them to break up the repetitive tasks into shorter segments. Other concepts include job sharing, part-time workers, shorter shifts, and work station rotation.

The above-noted attempts to solve the problems of RMI-type injuries are impractical and/or inefficient in many working situations. Further, none of the above-noted concepts addresses one of the roots of the problem; that is, improper interface between worker and work station. In fact, some of the concepts (e.g., job sharing and work station rotation) may actually exacerbate the problem by rotating workers (e.g., of different physical dimensions) through a single work station which is set up to accommodate the physical dimensions of only a single worker.

As noted above, one of the causes of RMI-type injuries is improper static working position (e.g., improper positioning of the worker relative to his/her work surface, such as a desk or table). Desk and table design has traditionally revolved around the anthropometric requirements of the 95th percentile male user (i.e., about 6′ 2″ tall) in order to “fit” the widest range of potential users. As a result, most users are forced to work in a position that is not the optimum (i.e., is too high) from a comfort, health and safety standpoint for their own particular physical dimensions, thereby causing the above-noted types of injuries. Further, although allowing a worker to change from a sitting to a standing position has been found to decrease workplace injuries, few desks are designed to allow a worker to stand while working.

Some attempts have been made to design work surfaces which are adjustable in height, thereby allowing modification to fit a range of worker dimensions and/or allowing workers to stand while working. However, many of these designs do not adequately accommodate a range of users from small females to large males. For example, to meet the adjustment range required to serve the 5th percentile sitting female (about 4′ 11″ tall) and the 95th percentile standing male (about 6′ 2″ tall), the work surface height must range from about 23 inches to about 50 inches. Many known designs cannot achieve the above-noted requirement without significant sacrifice of table rigidity due to inadequate extension member support when fully extended. Further, many of the known designs are not easily adjustable, and therefore are sometimes not utilized to their full extent because of the hassle in performing the adjustment procedure.

### DEFINITIONS

The terms defined in this DEFINITIONS section define terms used in the description of the invention. When a numerical label accompanies a term, the term with its label can be found in the figures accompanying this description.
Ergonomic: Webster's dictionary defines “ergonomics” as: “An applied science concerned with the characteristics of people that need to be considered in designing and arranging things that they use in order that people and things will interact most effectively and safely.” Accordingly, the term “ergonomic” as used herein denotes aspects related to a user environment (e.g., a user worksite) that can be controlled or adjusted so that the user can interact more effectively and safely with components of his/her environment.
Administration subsystem 54: A software program (also denoted an administrative console program) that allows individual user settings to be created/updated and provides output to a report generation module 108 (FIG. 1).
Authentication services: An operating system service that authenticates users and passwords, and allows or denies access to a computer and attached networks.
ODBC drivers: Open DataBase Connectivity Drivers: Drivers that allow a furniture table (more generally, an adjustable furniture unit as defined below) control program to communicate over a communications network with a settings and history database 100 (FIG. 1).
Adjustable furniture unit 90: This term denotes any component or apparatus of a user worksite 60 (FIG. 1) that can be adjusted via commands provided by a worksite computer 78, wherein such commands are determined using: (i) individual characteristics, limitations, and/or preferences of a user at the worksite, and (ii) expert advice for increasing the user's safety, comfort and/or effectiveness. Adjustable furniture units 90 may include computer adjustable tables, chairs, lighting controls, temperature controls, cushions, computer monitor positioning apparatuses, keyboard (and other computer input devices) placement, vehicle or machinery operator seats, beds, massage devices, and exercise devices.
Furniture (e.g., table) control program 130: Software on the user worksite computer 78 designed to communicate with the ergonomic settings and history database 100 and the furniture unit controller 134 (FIG. 1).
Furniture unit controller (control box) 134: An electrical box which: (i) translates signals transmitted to the furniture control program 130 on the worksite computer 78 from the computer controlled adjustable furniture unit 90 and/or the furniture hand control 140 so that such signals can be interpreted by the worksite computer for, e.g., recording user positioning over time in the history database 100, and/or (ii) translates signals transmitted by the worksite computer 78 to a furniture unit 90 so that such translated signals can used for activating motors/switches in the adjustable furniture unit 90 to make requested or preferred adjustments.
Furniture (e.g., table) adjustment commands: The commands sent to the furniture unit controller 134 to adjust various computer controlled adjustable furniture units 90.
Furniture hand control 140: A hand operated grouping of user controls (e.g., buttons and/or displays), memory cards and/or wireless proximity identification/detection devices that permit the adjustment of a computer controlled adjustable furniture unit 90 to be completed without involvement of the worksite computer 78.
Network 86: A communications network which may be a wide area or local area network or a network of networks such as the Internet. The present invention is not limited to a particular type of communication network. Thus, the network 86 be a TCP/IP network, an Ethernet based network, telephony network, and/or a wireless network.
Worksite: This term refers to any site where a user at the site where a user is authorized to be, and where there is adjustable furniture for addressing user ergonomic conditions. Accordingly, the term “worksite” includes a user's place of work that has such adjustable furniture. However, the term also includes user environments such as recreational settings, physical therapy settings, sleeping accommodations, vehicle seat settings, etc.

### SUMMARY OF THE INVENTION

The present ergonomic control system is an apparatus and method for control of ergonomic settings in, e.g., a high intensity computer workplace to benefit both employees and management. The present invention provides access and control for anthropometric measurements, ergonomic consulting, adjustable height electric computer tables with software for position control, chair adjustment settings, individual climate control settings, lighting and other adjustments to custom tailor the workstation to each individual user.

Embodiments of the present invention further include management reporting tools for recording and reporting adjustable furniture unit measurements and relationships to ergonomically preferred settings to thereby encourage, facilitate in the adoption of, and/or require or mandate proper ergonomic working postures (e.g., recommended by credible experts in the field of ergonomics and/or human physiology). Thus, the present invention may be used to record and report such measurements and relationships of workers at a worksite.

The present invention also allows for the storage and recall of ergonomically correct settings (e.g., at a central ergonomic administration system of the present invention) for an effectively unlimited number of users. Using data related to such ergonomically correct settings together with adjustable furniture user settings, users may be able to achieve optimal (or at least enhanced) personal comfort and productivity with, e.g., a simple click of a mouse (or other computer selection device). In particular, the present invention provides for the communication of ergonomic information between a user worksite having one or more computer controlled adjustable furniture and a central ergonomic administration system of the present invention, wherein the communication is, e.g., via a communications network. Thus, ergonomic information may be communicated between such an ergonomic administration system and the user's worksite, whether the worksite is at an employer's site or at a remote site (e.g., the user's home such as telecommuter employees) so that computer adjustable furniture may be configured at the worksite to the user's specific physical needs, work tasks, and preferences.

Embodiments of the present invention may provide reports (e.g., to employers/managers) for tracking historical workplace configurations by individual users, as well as generating exception reports and/or non-compliance reports for use in employee counseling and documentation of Human Resources issues relating to workplace injuries, OSHA or other regulatory compliance requirements.

In another aspect of the invention, each individual user may be provided with a range of ergonomic settings from which the user can select his/her preference. In particular, for a given furniture unit adjustment, a user may be presented with a range of settings including at least three adjustment values: an optimal or recommended adjustment, an upper limit of an acceptable adjustment range, and a lower limit of an acceptable adjustment range. Accordingly, by providing such an acceptable range of adjustment, the present invention accommodates individual user preferences within a “safe zone” recognized by credible experts in the field. Note that the user selected adjustment values may be determined by the end user or a consultant using independent third party standards established by the Human Factors and Ergonomics Society (HFES), the Occupational Health and Safety Administration (OSHA) in the United States, the International Organization for Standardization (ISO) in Europe and other regions, or by a recognized university, or by national or international government standards.

Moreover, since the ergonomic control system of the present invention may be distributed wherein various functional components of the invention are geographically dispersed, communications between such component may be transmitted on a communications network such as the Internet (or other wide area network) or a local area network. In an Internet embodiment, the present invention may be used to adjustably control furniture not only at work but at home, or while traveling. Accordingly, a user at home may, for example, connect his/her computer adjustable desk to a computer and access an Internet website that can provide ergonomic and/or therapeutic desk settings that are selected for the user.

Additionally, worksite aspects of the present invention may be provided in hotel rooms, restaurants, movies, and event stadiums to provide additional comfort to the users or patrons.

Other benefits and advantages of the present invention will become evident the Detailed Description herein below and the accompanying drawings.

### BRIEF DESCRIPTION OF THE DRAWINGS

FIG. 1. is a block diagram showing the high level components of the ergonomic control system 50 of the present invention.

FIG. 2 is a flowchart of the high level steps performed substantially at a worksite 60 (FIG. 1) for adjusting the settings of furniture unit(s) 90 at the worksite via the worksite subsystem 74 of the control system 50, and for initializing the worksite subsystem.

FIG. 3 is a flowchart of the high level steps performed for establishing appropriate communications: (i) between the worksite computer 78 and the one or more furniture units 90, and (ii) between the worksite computer 78 and the administration subsystem 54.

FIG. 4 is a flowchart of the high level steps performed to obtain the user's ergonomic settings for the furniture unit(s) 90 at the worksite 60.

FIG. 5 is a flowchart of the high level steps performed by the administration subsystem 54 for monitoring, reporting, and/or controlling the ergonomic settings of users at worksites 60.

FIG. 6 is a flowchart of the high level steps performed by the user initialization module 94 when registering a new user for thereby providing ergonomic settings to a worksite 60 utilized by the user.

FIG. 7 is a flowchart of the high level steps performed by the user initialization module 94 when configuring furniture unit 90 ergonomic settings at a new worksite 60 for a user.

### DETAILED DESCRIPTION

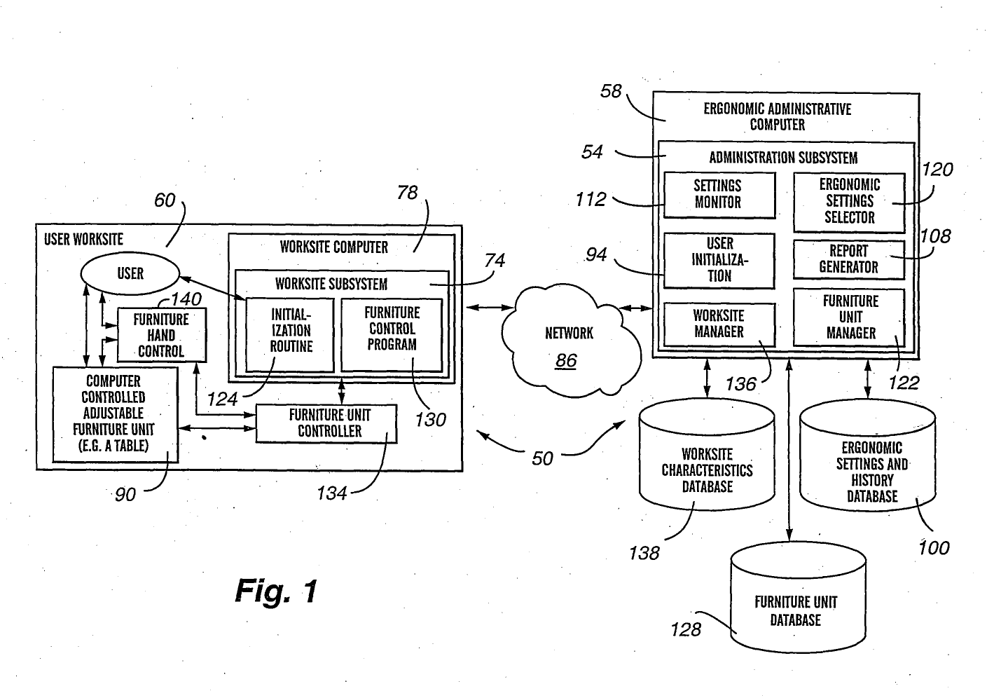

FIG. 1 shows the main components of the ergonomic control system 50 of the present invention. There are two primary subsystems of the control system 50. They are:
(1.1) an ergonomic administration subsystem 54 (also denoted herein as an “administrative server”) provided on a designated computer (denoted the “ergonomic administrative computer 58), wherein the administrative subsystem 54 manages, monitors, archives and creates reports related to ergonomic information received from a plurality of user worksites 60 (only one of which is shown in FIG. 1), and
(1.2) at each of one or more user worksites 60, a worksite subsystem 74 residing on a worksite computer 78 that cooperatively communicates, via a network 86, with the administration subsystem 54 for receiving ergonomic adjustment ranges for controlling the ergonomics of one or more computer controlled adjustable furniture units 90 (such as a table) at the user worksite 60, and for transmitting computer controlled adjustable furniture unit settings to the administration subsystem. Note that typically there will be a plurality of such worksites 60 in communication with the ergonomic administration subsystem 54, wherein such communication is substantially simultaneous (and likely asynchronous). Thus, for a first worksite subsystem 74 communicating with one or more furniture units 90 at a first of the worksites 60, and a second worksite subsystem 74 communicating with one or more furniture units 90 at a second of the worksites 60, there may be interleaved communications with the administration subsystem 54 while a first user is using one of the furniture units 90 at the first worksite and a second user is using one of the furniture units 90 at the second worksite. Moreover, note that the worksite subsystems 74 will generally be distinctly known to both the administration subsystem 54 and the network 86. In particular, there may be (and typically are) distinct network identifiers (e.g., addresses or URLs) for each of the worksite subsystems 74. Moreover, the administration subsystem 54 typically will have a network 86 identifier that is different from at least one (and likely at least most) of the network 86 identifiers for the worksite subsystems 74.

The administration subsystem 54 includes a user initialization module 94 for receiving new data from a worksite subsystem 74 regarding a new user and storing this information in the ergonomic settings and history database 100 which operably communicates with the administrative subsystem 54 for storing and retrieving ergonomic data. In particular, the settings and history database 100 includes structured data storage of three primary entity schemas, wherein each entity schema embodiment may be a data table if the database 100 is a relational database (although other databases such as object oriented, hierarchical and/or distributed databases are also within the scope of the invention). Accordingly, these three entity schemas can be described as follows (herein denoted “data tables” for convenience):
(2.1) A user data table for storing data for each user. Such data includes the following:
   (i) a user ID number that identifies the user,
   (ii) a user network logon name for identifying the user and thereby providing access to the network 86 and/or the ergonomic administrative computer 58, and consequently to various recommended ergonomic settings for the adjustable furniture unit(s) 90 of the user's worksite(s) 60 (e.g., table height, worksite temperature, table or chair angle, and/or lighting settings). In particular, ranges of ergonomic settings may be provided as specified by an ergonomic expert.
   (iii) additionally, the user data table may include data describing custom furniture unit 90 settings that are different from those normally recommended, such custom settings being for use on a temporary or permanent basis. Furthermore, such custom settings may have associated therewith: (a) an expiration or review date, wherein the settings monitor 112 (described further below) alerts the user and/or the ergonomic expert when such settings have expired or need to be reviewed, and (b) a variable length comment or description field wherein, e.g., the ergonomic expert and/or a user's supervisor may enter and store text providing additional description related to a particular user.
(2.2) A usage data table for storing the historical usage data for each user identified in the user data table. For each user identified in the user table, substantially every adjustment of the user's adjustable furniture unit(s) 90, and the time at each setting are recorded in the usage data table. The usage data table may used for subsequent analysis of ergonomic related injuries, and can be provided for printing to the report generator 108.
(2.3) A configuration data table for keeping a history of recommended user furniture unit(s) 90 settings so that these settings can be tracked over time. (e.g., if accepted ergonomic standards are revised, the history of settings used by a user can demonstrate compliance with the revised standards). Thus, the configuration data table records user specific ergonomic data provided to a user's worksite 60 by the administrative subsystem 54. In particular, such ergonomic data is likely input to the administrative subsystem 54 by an ergonomic expert. Note, that the configuration data table may include the following fields for each furniture unit 90:
   the type of furniture unit (e.g., chair, table, bed, exercise or therapeutic device);
   (ii) the make and model of the furniture unit 90;
   (iii) the location of the furniture unit 90;
   (iv) the time to furniture unit configuration data was received;
   (v) the time that the furniture unit configuration data was transmitted to a user worksite;
   (vi) the duration that the configuration data for the furniture unit 90 is to be in effect;
   (vii) preferred furniture unit 90 setting(s) and/or setting ranges;
   (viii) criteria indicative of at least one of: acceptable deviations from the preferred settings or setting ranges, and unacceptable deviations from the preferred settings or setting ranges. For example, such criteria may be a length of time or a frequency;
   (xi) data indicative of an over-ride condition, wherein the preferred furniture unit 90 setting(s) and/or setting ranges are over-ridden.

In addition to the user initialization module 94 and the report generator 108, the administration subsystem 54 further includes a settings monitor 112 for receiving periodic updates of furniture unit 90 settings from each of the user worksites 60 wherein a user has identified him/herself as working or residing at the worksite 60 having the furniture unit. Note that the settings monitor 112 may be used to vary the elapsed time between reported settings for a furniture unit 90 depending, e.g., on the type of furniture and/or the adjustment parameter being monitored (e.g., table height or chair inclination). Moreover, the settings monitor 112 may transmit messages to the user worksite 60 requesting a commencement (or cessation) of such updates when it is notified that a user just logged in (or is no longer logged in) to the worksite subsystem 74 at the worksite 60. Additionally, the settings monitor 112 may record, e.g., significant and/or persistent anomalies in furniture unit 90 settings for a given worksite 60 user; e.g., the settings monitor 112 may compare (a) recent and/or current furniture unit 90 setting measurements obtained while a user is utilizing the furniture unit, with (b) prescribed or preferred settings (or ranges thereof) for this user. In particular, such a comparison is used to determine at least one of: (i) whether there is a significant deviation and/or prolonged deviation between the data of (a) and (b) immediately above, and (ii) whether there is a consistency with between the data of (a) and (b) immediately above.

The administration subsystem 54 also includes an ergonomic settings selector 120 for determining for each of one or more users logged in at a worksite 60, the range of ergonomic settings and recommended optimal settings for one or more furniture units 90 at the worksite. Note that the settings selector 120 may use both the normally recommended ergonomic ranges for a particular user and furniture unit 90, as well as custom settings to accommodate unique user conditions which may require user settings different from those normally recommended. Accordingly, the settings selector 120 may override any normal or recommended ergonomic settings with custom settings. Furthermore, the settings selector 120 may enter into a networked interactive session with a user for identifying a more user desirable range of ergonomic settings. Such a session may include contacting or notifying of an ergonomic expert for assisting with determining more preferred ergonomic settings for the user. In one embodiment, the settings selector 120 provides the functionality for allowing an ergonomic expert to enter settings (e.g., optimal settings, plus an acceptable range of ergonomic settings) for a new user or to edit ergonomic settings for an existing user. Thus, the ergonomic expert accesses the administration subsystem 54 via the settings selector 120 for reviewing and responding to worksite user messages regarding difficulties they may be experiencing. In particular, in at least some embodiments, the ergonomic expert may access the administration subsystem 54 via the Internet. Additionally, the ergonomic expert may be able to review, e.g., electronic versions of reports generated by the report generator 108, or query the settings and history database 100 for worksite user conformance with prescribed or preferred ergonomic settings for a user. Moreover, the expert may subsequently, modify a user's ergonomic settings, request a meeting with a user (e.g., via email), and/or notify a user's supervisor/manager of the user's deviation from his/her ergonomic settings. Moreover, it is also within the scope of the control system 50 that a manager and/or the ergonomic expert may be notified of out of compliance usage by a user. Accordingly, the manager and/or the ergonomic expert is then able to make a determination as to whether: (i) additional training or a further explanation of the potential benefits to proper or prescribed user positions at a worksite 60 user is needed for thereby resolving such discrepancies between actual usage settings and assigned settings, or (ii) such discrepancies should be documented in the event that the user experiences related physical problems in the future. Note that at least some preferred embodiments of the present invention are intended to be used with national and/or international standards (e.g., for ranges of adjustment, HFES 100, ISO 9241, etc.) related to proper ergonomic settings. Preferably such national and/or international standards will be used for initial universal ergonomic settings for a population of employees or users who are not injured and/or are not experiencing any symptoms which would indicate a propensity for such injuries.

Moreover, an ergonomic expert may measure and test various individual users to determine recommended customized adjustable furniture unit 90 settings based on such established national and international standards such as ISO 9241. In particular, temporary or permanent physical needs of a user may require such custom settings to be created. Thus, the recommended settings and acceptable ranges (e.g., for heights, temperature, brightness, angles) are then entered into the settings selector 120 and saved to the user configurations database 100.

In an alternative embodiment, the settings selector 120 may also include an intelligent agent such as an expert system or other intelligent agent for at least temporarily assisting a worksite user with determining modifications to the user's ergonomic settings. Thus, such an intelligent agent (commonly referred to as a “wizard”) may interact with the user in lieu of or in addition to the ergonomic expert. Moreover, the settings selector 120 may be used to dynamically vary adjustable furniture unit 90 settings to provide a user with periodic adjustments to furniture unit(s) 90; e.g., for chairs having various inflatable/deflatable compartments, the settings selector may vary the inflation of such compartments; for adjustable tables, the height of the table may vary.

The administrative subsystem 54 may also include a furniture unit manager 122 for managing information related to, e.g., the ergonomic characteristics and functional capabilities of various types of adjustable furniture units 90. In particular, the furniture unit manager 122 allows authorized persons to: (i) enter information descriptive of new types of furniture units 90 into the furniture unit database 128; (ii) delete information descriptive of furniture units 90 from the furniture unit database 128; (iii) modify information descriptive of furniture units 90 from the furniture unit database 128; and (iv) retrieve information descriptive of furniture units whose data resides in the furniture unit database 128.

Various embodiments of the furniture unit database 128 may include, for each of one or more particular furniture units 90 (FU), one or more of the following types of furniture unit descriptive information:
(3.1) General furniture unit classification (e.g., a table, a chair, vehicle seat, bed, etc.) for FU.
(3.2) An identifier for uniquely identifying FU.
(3.3) The make and model of FU.
(3.4) The physical location of FU.
(3.5) Operating characteristics of FU (e.g., data identifying to what extent the furniture unit is operative; data describing how to operate the furniture unit and its electrical power requirements; and/or data describing sensors provided with the furniture unit).
(3.6) For each computer adjustable attribute of FU:
   (i) A description of the attribute (e.g., table height, chair back tilt, etc);
   (ii) The range of the adjustment; and/or
   (iii) Format and description of attribute adjustment command(s).

The administrative subsystem 54 may also include a worksite manager 136 for managing information related to the worksites 60. In particular, the worksite manager 136 allows authorized persons to: (i) enter information descriptive of new worksites 60 into the worksite characteristics database 138; (ii) delete information descriptive of worksites 60 from the worksite characteristics database 138; (iii) modify information descriptive of worksites 60 from the worksite characteristics database 138; and (iv) retrieve information descriptive of worksites 60 whose data resides in the worksite characteristics database 128.

Various embodiments of the worksite characteristics database 138 may include, for each of one or more worksites 60 (WS), one or more of the following types of furniture unit descriptive information:
(4.1) The location and/or identification of the worksite (e.g., address, office/room number, and/or suite number).
(4.2) The activities to be performed at the worksite.
(4.3) The size of the worksite (optional).
(4.4) The communication network availability at the worksite (optional).
(4.5) The electrical availability at the worksite (optional).
(4.6) The identifier(s) for the furniture unit(s) 90 at the worksite (optional).

The worksite subsystem 74 of the ergonomic control system 50 also includes an initialization routine (or collection of routines) 124 for interactively communicating with a new user and/or interacting with a current user whose physical condition has changed (e.g., the user has had a recent hernia surgery, or is no longer pregnant, or can not sit in a particular position due to a tailbone problem). The initialization routine 124 cooperatively communicates with the user initialization module 94 and/or the settings selector 120 for obtaining user information for initializing data for anew user or obtaining additional information related to a current user's physical condition. For a new user, the result of an interactive session between the initialization routine 124 and a user includes the capturing of the information about the user's physical condition for thereby populating a record for the user in at least the user data table (2.1) above.

For an interactive session between the initialization routine 124 and a current user, e.g., initiated due to lower back problem, in one embodiment of the invention, the following describes the user interactions and control system 50 processing performed. The selector 120 may notify a designated person such as an ergonomic expert so that temporary customized settings may be developed to allow the furniture unit(s) 90 to meet the user's current needs. Accordingly, settings may be developed to match physical restrictions and entered into the setting selector 120.

The worksite subsystem 74 also includes a furniture control program 130 (or collection of programs) for communicating with each computer controlled adjustable furniture unit 90 at the worksite 60. In particular, the furniture control program 130 outputs to each furniture unit 90, via a furniture unit controller 134, adjustment commands for changing, e.g., a height, tilt, or angle of a furniture unit 90 or a component thereof (e.g., a chair back, a chair arm rest). Note that in one embodiment, the furniture control program 130 may (using information supplied by the settings selector 120) periodically change the furniture unit 90 adjustments so as to provide a way of varying of the user's posture or position while working. Note, that such a change may be performed by requesting the user's acceptance of the change, or the change may be performed automatically without the user's intervention. Thus, this aspect of the invention may be particularly beneficial for users that are not able to stay in one position for an extended amount of time. For example, instructions may be periodically communicated to a computer controlled adjustable chair so that the chair back may be caused to vary its angle between 10 degrees from vertical to 20 degrees from vertical over an elapsed time of, e.g., 30 minutes. Similarly, the height of a computer controlled adjustable table may be varied over a predetermined elapsed time. Additionally, a cushion in the user's chair or bed may be adjustably inflated/deflated to accommodate a particular physical condition, and/or the cushion may automatically cycle through various inflation/deflation patterns under the control of the furniture control program 130.

Additionally, the furniture control program 130 receives input from the adjustable furniture unit(s) 90 via one or more furniture unit controllers 134. In particular, the furniture control program 130 may receive data indicating that a requested command can not be performed and/or that the user has explicitly changed the settings of a furniture unit 90 via, e.g., a corresponding furniture hand control 140 which can also be used to adjust the furniture unit 90. In some embodiments, such explicit user setting changes may be forwarded to the furniture control program 130. Accordingly, such explicit changes may be incorporated into the user's furniture settings stored in the settings and history database 100.

More detail on the above described invention components will now be described.

The administration subsystem 54 must be installed on a computer (i.e., the ergonomic administrative computer 58, FIG. 1) with authentication services wherein the subsystem 54 can be accessed via the network 86 by virtually all authorized users. During the installation of the subsystem 54, a directory (denoted the “admin-directory” hereinbelow) is created and network access permissions to the directory are provided for each user worksite computer 78. Note that access to this shared directory is based on the operating system (e.g., Microsoft WINDOWS based operating systems: Windows 95, 98, Me, NT, 2000, XP; or UNIX) user authentication services, as one skilled in the art will understand. The shared admin-directory is used to provide access to the settings and history database 100 via database ODBC drivers (i.e., Open DataBase Connectivity drivers) that allow programs to communicate with the database 100, as one skilled in the art will understand.

Once the administration subsystem 54 is installed on the administrative computer 58. Icons are created for display to an operator, wherein these icons may be presented to the operator in various contexts; e.g., for the Microsoft WINDOWS series of operating systems. Such icons may be provided in program groups on the start menu, on the desktop, and/or in the startup program group, as one skilled in the art will understand. In particular, icons may be created for activating the following tasks: the report generator 108, the ergonomic setting selector 120, the settings monitor 112, the worksite manager 136, user initialization 94.

The furniture control program 130 is preferably installed on each user worksite computer 78. The furniture unit controller(s) 134 and the corresponding user worksite computer 78 are then connected with each furniture unit 90 via, e.g., a serial connection cable having an encased communications chip therein for converting transmissions between the furniture unit 90 and the worksite computer 78. In particular, furniture adjustment commands are output from the worksite computer 78 to an RS232 serial port, and subsequently to a corresponding furniture unit controller 134 wherein the commands are translated into an appropriate protocol that can be interpreted by the connected furniture unit(s) 90. Conversely, data output by each furniture unit(s) 90 (e.g., indicative of adjustment settings) can be translated by the output receiving furniture unit controller 134, wherein the result of the translation may provide corresponding data in a signaling protocol such as protocols for USB, IEE1394 (FireWire), or Ethernet which can be, in turn, interpreted by the worksite computer 78 and/or the worksite subsystem 74. Note that one such furniture unit controller 134 may be a serial control cable for a computer adjustable table manufactured by, LogicData, in Frauental, Austria, the cable model being denoted as DCC. Further note, however, that it is within the scope of the present invention for such signaling transmissions between worksite computer 78 and the one or more computer adjustable furniture units 90 at a worksite 60 to be wireless. In particular, BlueTooth and/or IEEE 802.11b wireless technologies may be used for the signaling transmissions, and in such cases, portions of the furniture unit controller may reside at both the furniture unit 90 and the worksite computer 78.

Additionally, during the worksite subsystem 74 installation, icons may be created for the user in program groups on the start menu, on the desktop, and in the startup program group as with the installation of the administration subsystem 54. In particular, icons may be created for activating the following tasks: launching the furniture control program 130, or communicating with the administrative subsystem 54.

When the furniture control program 130 is first run on a user worksite computer 78, the program queries the operating system for the current user's network logon name (i.e., for network 86). Then the program 130 checks for the current user's network logon name in the user data table in the ergonomic settings and history database 100. If the network logon name is present, then the user's current settings are retrieved from the user data table in the database 100, or at least the user's current setting(s) for the furniture unit(s) 90 at the worksite 60. If the network logon name is not present in the user data table, the user is assumed to be a new user and a new user set-up dialog box is displayed to the user via the initialization routine 124. The new user may be required to enter one or more of the following information items (that are not already accessible to the initialization routine 124) into the dialog box:
(5.1) The name of the networked administrative computer 58 that hosts the user settings and history database 100.
(5.2) The COM port(s) (not shown) of the user worksite computer 78 to which the adjustable furniture unit(s) 90 is connected; note, such COM port(s) may be automatically determined by the furniture control program 130 polling the COM ports of the worksite computer 78 to determine which such ports have furniture a unit controller 134 connected thereto.
(5.3) For each computer adjustable furniture unit 90 (operably connected to the present invention), the user's desired position or orientation of the furniture unit, such as when the user is in a first relationship to the furniture unit (e.g., in a sitting position on or adjacent thereto). In particular, the user may be able to select from a range of standard preferred ergonomic positions or orientations, and/or a range of positions or orientations developed by an ergonomic expert specifically for the user. Note that in one embodiment, the information presented to the user may include a range including the extreme settings of the range and a recommended setting(s).
(5.4) Optionally, for one or more of the computer adjustable furniture units 90 (operably connected to the present invention), the user's desired position or orientation of the furniture unit 90 when the user is in a second relationship to the furniture unit (e.g., in a sitting standing position on or adjacent thereto). In particular, the user may be able to select from a range of standard preferred ergonomic positions and/or a range of positions developed by an ergonomic expert specifically for the user. Note that in one embodiment, the information presented to the user may include a range including the extreme settings of the range and a recommended setting.
(5.5) Physical characteristics of the user, such as height, weight, medical conditions (e.g., heart condition, pregnancy, etc.), physiological restrictions (e.g., lower back discomfort, sprained ankle, etc.).
(5.6) The task that the user is to perform at the worksite 60 and the interactions that the user will have with various furniture units 90. For example, any adjustable table may be used quite differently by a computer data entry person or secretary as opposed to a sketch artist or a radio sound person.
(5.7) Once the user's settings have been established (via retrieval from the settings and history database 100 or resulting from a new user initialization process) the furniture control program 130 checks to determine whether the adjustable furniture unit 90 requires initialization for communicating with the user worksite computer 78. If the adjustable furniture unit 90 needs to be initialized (e.g., after a power outage or when first plugged in to power), the furniture control program 130 may first put the adjustable furniture unit in a predetermined position such as the lowest position in the case of the furniture unit being a table. Once the furniture unit 90 is in this predetermined position, the furniture unit 90 can then be adjusted via adjustment data commands from the furniture control program 130. In particular, a screen (and/or iconic or miniature representation thereof) may be presented on the user's computer monitor (not separately shown, but attached to the worksite computer 78) providing the current settings for the furniture unit 90. Note that the user may be able to change the settings for the furniture unit 90; e.g., when the furniture unit is a table, the user may be able to input table height adjustments via a furniture control program 130 graphical user, interface presented on the monitor. Moreover, with a single input selection action (e.g., a mouse click) the user may be able to change the table height between a height to be used when the user is in a first position (e.g., sitting) and a height to be used when the user is in a second position (e.g., standing). Additionally, in one embodiment, an image of the user at the table is presented on the monitor in the corresponding current state of being, e.g., seated or standing, and the image changes colors as the table is adjusted into and out of recommended range for the current state. For example, the image may be green when the user's current position setting is a recommended optimal position, yellow when the user's current position is in an acceptable position, and red when the user's current position is outside of the recommended range of positions. Note that such graphical changes can be applied to iconic representations of each of one or more furniture units wherein such representations are displayed in, e.g., the system tray on the user's monitor as one skilled in the art will understand. Moreover, in one embodiment, a right mouse click (or other single action user input) may allow the user to select between options on a menu such as: table height when the user is seated (more generally, in a first position), table height when the user is standing (more generally, in a second position), and manually adjust the table height to a user specified height.
(5.8) After a furniture unit 90 is adjusted using the furniture control program 130 or the (any) furniture hand control 140, the furniture control program records the change in relationship to the user (e.g., position to the user) and sends the time and current relationship(s) of the furniture unit(s) to the settings and history database 100 (via the network 86 and the administrative computer 58). In one embodiment, position data for a furniture unit 90 is updated in a range of about a minute to five minutes after requested changes to the furniture unit have been completed (e.g., furniture unit adjustment motion has stopped). In this way, if a user is making a lot of adjustments over a short period of time (i.e. demonstrating how the control system 50 works to another user) the administration subsystem 54 will not record all of the interim movements, thereby keeping the database 100 clean of furniture unit 90 position data that was not used for an extended time. Note that the furniture control program 130 also monitors when the user logs out from the worksite computer 78, and sends (for each furniture unit 90 connected to the worksite computer 78) a final position and time to record in the database 100.

Regarding the operation of the administration subsystem 54, this subsystem transmits proper furniture unit 90 settings to the user worksites 60. Moreover, an operator at a display operably connected to the administrative computer 58 can display the following information:
(6.1) The users that are currently logged on to the control system 50;
(6.2) For each logged on user, the current settings of each furniture unit(s) 90 at the user's worksite 60; e.g., a table height in centimeters;
(6.3) For each furniture unit 90 at the user's worksite 60, an iconic representation of the state of the user in relation to the furniture unit 90; e.g., for a computer adjustable table, whether the table height is in a state for the user to stand or for the user to sit.
(6.4) Color changes of the iconic representation of (6.3), wherein the color changes are indicative of whether the furniture unit(s) 90 is in an a recommended (e.g., green) position, an acceptable position (e.g., yellow), or outside of a recommended range (e.g. red);
(6.5) For each furniture unit 90 at the user's worksite 60, the time that the furniture unit has been in its current position.

Note that, in addition, an operator of the administration subsystem 54: (i) can display the current settings of all furniture units 90 at a user's worksite 60, and (ii) can edit/update the recommended settings for a worksite 60 user such that the edits/updates are stored in the database 100.

Regarding the functionality of the report generator 108, the report generator allows an operator to select different options to generate reports such as the following:
(7.1) Select a range of dates for reporting: e.g., one or more of:
   (i) A time period for the report, e.g.: a day, a week, a month, a year.
   (ii) Start date for the report time period;
   (iii) An end date for the report time period.
(7.2) Select the user(s) for which a report is to be generated, e.g.:
   (i) all users,
   (ii) operator selected users;
   (iii) users using furniture unit 90 settings, over an extended time, wherein the settings are outside of a prescribed or predetermined range(s).
(7.3) Select a report type to be generated, e.g.:
   (i) Usage report—generates a report of all movements of selected types of furniture units 90 for selected user(s),
   (ii) Non-compliance report—generates a report of out of recommended range setting statistics for selected users,
   (iii) Positions report—displays preferred positions for each user.

Additionally, note that an operator and/or a worksite 60 user can choose usage options to match corporate safety policies. For example, the operator and/or user can adjust settings at a furniture unit 90 by, e.g.:
(8.1) A click and hold interaction, wherein the user or operator may click an input selection device (such as a mouse) on a button of a user (alternatively operator) interface identifying the furniture control program 130 (in the user case) or the settings selector 120 (in an operator case) to thereby activate the furniture control program 130 (at a worksite 60) and initiate a setting adjustment, wherein the user (alternatively operator) may continue holding the button until the position has been achieved by the activated furniture unit 90. For example, if the furniture unit 90 is a computer adjustable table, and a user desires to switch the height of this table from that corresponding to a seating position to that corresponding to a standing position, clicking and holding the button of the graphical interface to the furniture control program 130 will initiate movement of the table height towards the setting corresponding to the standing position for the user. Note, as long as the user continues to hold the button down, the table will continue to move towards the standing position until either the user releases the button or the table achieves the optimal or recommended range for a standing position and thus stops adjusting (unless such a range is over-ridden). Note, this feature requires more attention to be paid to the adjustment process by the user (or operator) than other techniques for changing furniture unit 90 settings; and/or
(8.2) For a selected user, an operator can initiate a change in a furniture unit 90 position by transmitting data indicative of a desired furniture unit 90 final configuration.

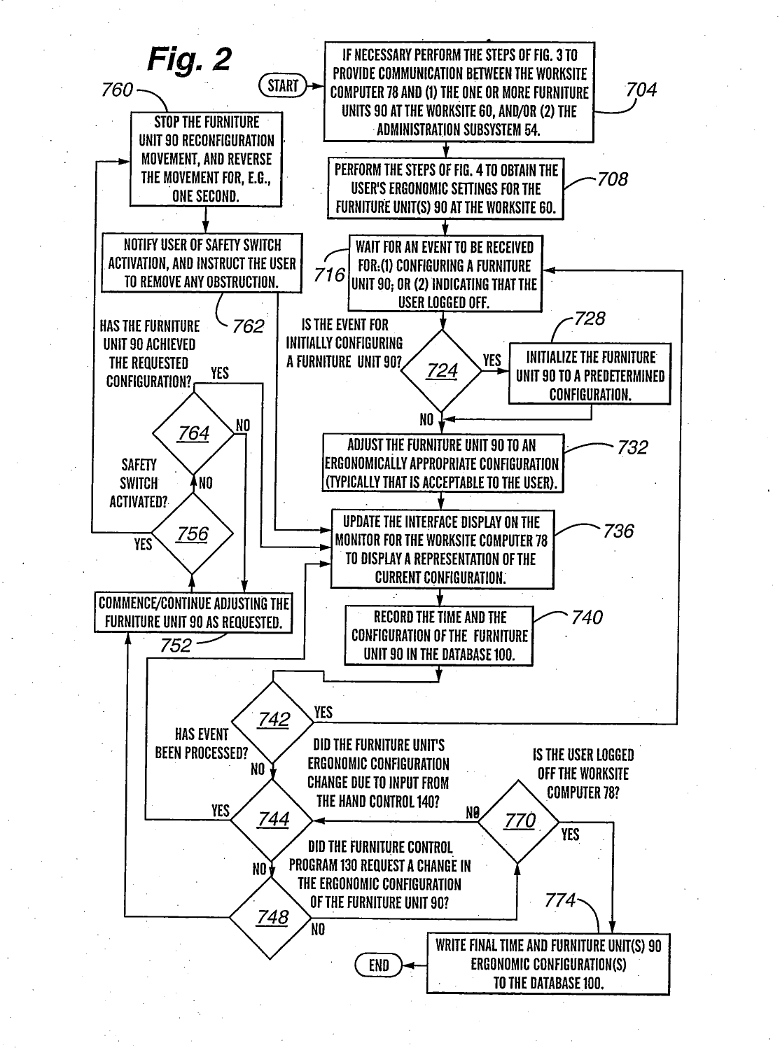

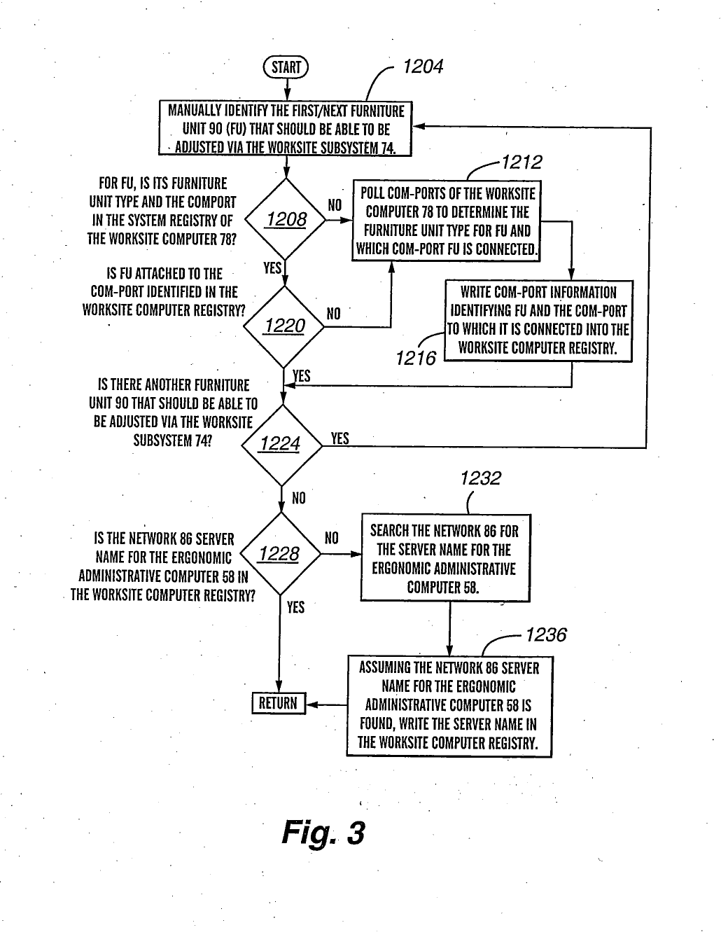

FIG. 2 shows the high level steps performed by the ergonomic control system 50 of the present invention when a user at a user worksite 60 activates the control system 50 for initializing the worksite computer 78 communications with the furniture units 90, for initializing the worksite computer 78 communications with the ergonomic administrative computer 58, for registering the user (if necessary) with the administration subsystem 54, and for adjusting a position of one or more furniture units 90 (such as a table height) that are operably connected to the worksite computer 78. Thus, it is within the scope of the present invention for the steps of FIG. 2 to be performed for adjusting, e.g., a table tilt, a chair height or angular orientation, a computer monitor orientation, a position of a computer keyboard, workstation temperature, brightness of workstation lighting, and/or the relative position between such worksite components which may cause the user to remain in a restricted position for an extended period of time (e.g., one hour or longer repeatedly for a succession of workdays). Accordingly if there is one or more furniture units 90 at the worksite 60 that are not operably connected to the worksite computer 78, then the steps of the flowchart of FIG. 3 are performed at step 704 for establishing the appropriate communications between the worksite computer 78 and the one or more furniture units 90. Additionally, step 704 (i.e., FIG. 3) establishes that there is appropriate communications between the worksite computer 78 and the administration subsystem 54. The flowchart of FIG. 3 will be described further below.

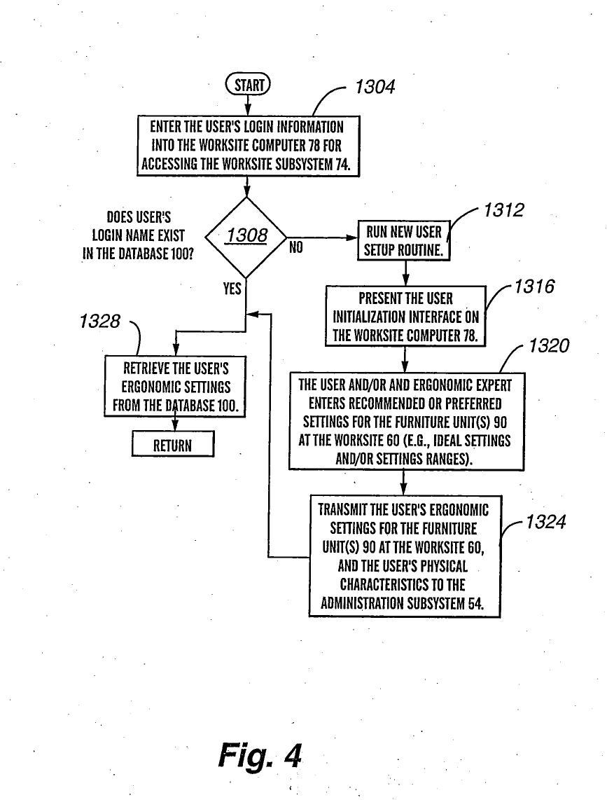

Subsequently, in step 708, the steps of the flowchart of FIG. 4 are performed to obtain the user's ergonomic settings for the furniture unit(s) 90 at the worksite 60. FIG. 4 will be described further below. However, note that step 708 provides for the registration of the user with the ergonomic control system 50 (if necessary), the determination of the user's ergonomic settings for the furniture unit(s) 90 at the worksite 60 (if necessary), and/or the retrieval of the user's ergonomic settings from the administration subsystem 54.

In the remaining steps of FIG. 2, the furniture control program 130 processes events that are directed to it. Thus, in step 716, the furniture control program waits for an event for which it designated to process. In FIG. 2, two types of events are processed by the furniture control program 130; they are: (i) an event for (re)configuring a furniture unit 90, and (ii) an event for indicating that the user has logged off. Accordingly, in step 716, the furniture control program 130 waits, until one of these events occurs.

Accordingly, in step 724 a determination is made as to whether the event received is for initially configuring the ergonomic setting(s) for a furniture unit 90 operatively connected to the worksite computer 78. If so, then in step 728, the furniture control program 130 generates and transmits a command to the furniture unit 90 to adjust itself to a predetermined known configuration (e.g., for a computer adjustable table such a command may be to reduce its height to, a known lowest position). Whether such an initialization of the furniture unit 90 is unnecessary or alternatively the initialization is performed as in step 728, step 732 is then performed wherein the furniture unit 90 is adjusted to an ergonomically appropriate configuration (e.g., for a computer adjustable table, its height may be adjusted to a recommended height), typically with the user's permission. Subsequently, in step 736 the display at the worksite computer 78 (and optionally at the administrative computer 58) are updated to show the relationship of the user to the furniture unit 90. For example, for the furniture unit 90 being a computer adjustable table, display may provide a representation of whether the user is standing or sitting and additionally display data indicative of the height of the table (e.g., centimeters and/or color as described above). Moreover, in step 740 the time of the furniture unit 90 configuration and the parameter values indicative of the ergonomic configuration (e.g., the table adjusted height) are stored in the database 100. Subsequently, in step 742, a determination is made as to whether the event received in step 716 has been processed. If so, then step 716 is again performed. Alternatively, the event may be related to a further (re)configuration of a furniture unit, or a log out by the user.

Regarding an event for reconfiguring a furniture unit 90, the furniture unit (e.g., a table) remains at the initial configuration (e.g., the initially set table height or range of heights) to which the furniture unit was adjusted in step 732 until there is a request to change the furniture unit's ergonomic configuration (e.g., table height) from a source external to the furniture control program 130 (e.g., a request from the administration subsystem 54). Accordingly, the furniture unit's configuration may be changed either via the user activating such a change using the (any) furniture hand control 140, or via an output to the furniture unit 90 from the furniture control program 130. Thus, if the received event indicates that the ergonomic configuration of the furniture unit 90 is adjusted using the furniture hand control 140 (step 744), then step 736 is again performed wherein the user interface for the furniture control program 130 is updated and step 740 is again performed. Alternatively, if the ergonomic configuration of the furniture unit 90 is adjusted using an output from the furniture control program 130 (step 748), then the furniture unit 90 reconfigures itself to the newly requested configuration (step 752). While the furniture unit 90 is adjusting to its new configuration, a safety switch may be monitored for activation. Such safety switches are provided in computer adjustable furniture units 90 that physically move when reconfigured (as opposed to furniture units that change a worksite lighting, temperature, dr air circulation). In particular, if such a safety switch is provided with the furniture unit 90, then the safety switch is activated when sensors (not shown) in the furniture unit 90 detect an anomalous condition related to the reconfiguration movement of the furniture unit. For example, there may be sensors for detecting an inordinate load on a motor for reconfiguring the furniture unit (e.g., changing the height of a computer adjustable table), or a sensor that is activated when the furniture unit appears to be off balance. Accordingly, if the movement of the furniture unit 90 causes one or more safety switches to be activated (step 756), an output will be transmitted to the furniture control program 130. The furniture control program 130 will then (in step 760) stop further reconfiguration movement of the furniture unit 90 and subsequently reverse the direction of one or more configuration movements for, e.g., one second. Such movement reversal will typically release or inactivate the safety switch from the obstruction. This reversal is referred to as a safety bounce in the art, and is intended to release an individual or object or obstruction that may be hindering the reconfiguration movement of the furniture unit 90. Additionally, in step 762, the furniture control program 130 notifies the user (via the computer display operably connected to the worksite computer 78) that a safety switch on the furniture unit 90 has been activated so that the user can inspect the furniture unit and remove the hinder to the reconfiguration of the furniture unit. Note that such notification may be a pop up window identifying the furniture unit 90, and identifying where and/or the type of the hindrance detected. Following this, step 736 is again performed wherein, e.g., an iconic representation of the furniture unit 90 is represented as being in a “reconfiguration blocked” state; e.g., the iconic representation of the furniture unit may blink in a distinct color (e.g., red) on the worksite computer 78 display.

Referring to step 756 again, if the safety switch is not activated, then (in step 764) the furniture control program 130 periodically accesses configuration data received from the furniture unit 90 to determine whether the furniture unit has achieved the requested configuration. If the requested position has not been achieved, then step 752 is repeated.

Moreover, note that the user interface on the worksite computer 78 display is updated to show the current furniture unit(s) 90 configuration(s). However, if the requested furniture unit 90 configuration is achieved, then the furniture control program 130 instructs the furniture unit to stop movement and step 736 is again performed.

Referring to step 748 again, if the furniture control program 130 did not request a change in the in the ergonomic configuration of the furniture unit 90, then in step 770 a determination is made as to whether the received event indicates that the user has logged off the worksite computer 78. Note that detecting such a log off is interpreted to mean that the user is terminating his/her work session at the worksite 60. Further note that it is within the scope of the present invention that other techniques and/or inputs may also be used as indicative of the user terminating his/her work session. For instance, as long as the worksite computer 78 is operating, furniture unit 90 could be monitored for determining whether it is still being utilized by the user (e.g., a computer adjustable chair may have a weight sensor and even though the user may log out at the worksite computer 78, the worksite subsystem 74 may still monitor and/or adjust the furniture unit(s) 90 at the worksite 60 until, e.g., the chair is determined to be unoccupied for a predetermined time and the lights at the worksite have been turned off).

Thus, assuming that an event was detected (in step 770) that indicates that the user logged off of worksite computer 78, then in step 774 the furniture control program 130 transmits the user's log off time and the final ergonomic furniture unit settings to the administration subsystem 54 so that this information can be stored in the database 100.

Referring to FIG. 3, this flowchart: (a) establishes appropriate communications between the worksite computer 78 and the one or more furniture units 90 at the worksite 60, and (b) establishes that there is appropriate communications between the worksite computer 78 and the administration subsystem 54. In step 1204, a person (e.g., the user and/or an ergonomic expert) at the worksite 60 manually identify the furniture unit(s) 90 that are to be in communication with the worksite subsystem 74. Accordingly, for each such furniture unit 90 (denoted FU) identified, steps 1208 through 1220 are performed for assuring that FU and the worksite computer 78 can properly communication with one another via the furniture unit controller 134. Thus, assuming that FU, its corresponding furniture unit controller 134 and the worksite computer 78 are each able to send and receive signals (via wires or wireless) the other two devices, in step 1208 a determination is made as to whether FU is appropriately designated in the operating system registry of the worksite computer 78. For example, the following FU description information may be entered into the worksite computer registry: (i) an identification of the worksite computer communications port for receiving and transmitting data to FU, and (ii) type and capabilities of furniture unit 90. If appropriate FU information is not found in the registry (e.g., by visually inspecting a display of registry entries), then in step 1212 an operating system command may be issued directing the worksite computer 78 to poll its communication ports (denoted herein “COM-ports”) to determine the furniture unit type for FU and the COM-port through which communications with FU can be received and transmitted. Assuming that appropriate FU registry information results from the polling command, in step 1216 this FU registry information is entered into the worksite computer 78 registry.

Referring to step 1208 again, if the worksite computer registry includes information identifying FU and a COM-port, then in step 1220, a determination is made as to whether the FU information in the registry identifies the correct COM-port. If not, then steps 1212 and 1216 are performed.

If in step 1220 it is determined that the worksite computer registry information for FU is correct, or step 1216 has been performed to correct the registry, then in step 1224 a determination is made as to whether there is an additional furniture unit 90 at the worksite 60 that should be operably connected to the worksite computer 78. If so, then the flow of control returns to step 1204 for establishing that there is appropriate information in the worksite computer's registry about this additional furniture unit 90. Alternatively, upon a negative result from step 1124, all furniture units 90 at the worksite 60 are able to appropriately communicate with the worksite subsystem 74.

In step 1228 a determination is made as to whether the network 86 server name for the ergonomic administrative computer 58 is identified in the registry of the worksite computer registry. If not, then in step 1232 a search is performed for determining this network server name. In particular, this search may be performed by searching the available network computers for the predetermined network server name. If the server is located, record the name of the computer (server). If the network server name can not be found, then request that the user contact the administrator to obtain the proper server name and allow the user to manually enter the server name.

Subsequently, in step 1236, assuming the network 86 server name is obtained for the ergonomic administrative computer 58, this server name is entered into the worksite computer register; more specifically, the server name is entered in the system registry as in a Microsoft Windows implementation. Following step 1236, processing returns to FIG. 2.

Referring to FIG. 4, this flowchart provides an embodiment of the high level steps to obtain the user's ergonomic settings for the furniture unit(s) 90 at the worksite 60. Thus in step 1304, the user's login is entered into the worksite computer 78 for thereby accessing the worksite subsystem 74. When the user logs in (or attempts to login) to the worksite computer 78 at the user worksite 60, the worksite subsystem 74 is activated for determining if the user's login identifier (e.g., username) is known to the ergonomic control system 50. In particular, the user's login identifier is captured by the furniture control program 130 and transmitted to the ergonomic administrative computer 58 (herein also denoted the “administrative computer”), and more particularly, to the administration subsystem 54 for determining whether there is information identifying the user in the database 100. Subsequently, this later subsystem queries the user ergonomic settings and history database 100 for any ergonomic settings associated with the user's login.

Subsequently, in step 1308, a determination is made as to whether the user's login information is found in the database 100. If the user is unknown or has no appropriate user ergonomic settings stored in the user ergonomic settings database 100, then the administration subsystem 54 sends a message to the user's worksite computer 78 (via network 86) indicating that ergonomic related information is needed from the user. Additionally, in steps 1312 through 1320 the user initialization routine 124 is activated at the worksite computer 78 for gathering user ergonomic related information for thereby determining an ergonomic working environment for the user, such as ergonomic expert recommended table and chair heights, table and chair angles, worksite temperatures, worksite lighting brightness settings, and firmness of a computer adjustable chair. Note that steps 1312 through 1320 may be performed at the worksite 60 with the assistance of an ergonomic expert that is assigned to initially set the ergonomic settings at the worksite 60 for the user. Alternatively, an ergonomic expert may have previously configured ergonomic settings at the worksite 60 (and/or for the furniture unit(s) 90 at the worksite) for various user physical characteristics (e.g., as described in (5.5) hereinabove). Accordingly, when a new user (or, e.g., a user moving to a different worksite 60) is fitted for a new computer adjustable chair, he/she may also be fitted for a computer adjustable table, and the preferred ergonomic settings and ranges for the various adjustable furniture units 90 be may determined by an ergonomic expert at the worksite together with the user, or such settings and ranges may have been predetermined substantially via ergonomic expert interactions with the initialization routine 124, or, such settings and ranges may be determined by the user interacting with the furniture control program 130 (possibly in combination with Internet, phone or email communications with an ergonomic expert at a remote location).

Additionally, note that for some furniture units 90 there may be a number of different adjustment parameters that may be set for the user. For example, many computer adjustable tables have adjustable setting for the height of a computer keyboard support, and the height settings of this support can be one of the most important ergonomic considerations for providing the user with a safe and effective work environment. Thus, for adjustable tables having computer adjustable keyboard supports, user arm length as well as height may be useful in determining appropriate keyboard support heights. Thus, for a new user, these settings may be determined in step 1320.

Note that the new user setup routine activated in step 1312 is provided by initialization routine 124, and this new user setup routine may be interactive with the user (and/or ergonomic expert) depending on the user's (and/or ergonomic expert's) input. For example, in response to a question as to whether the user has previously had work related injuries caused by repetitious movements (or lack thereof), and/or back problems, and/or fatigue when sitting for more than, e.g., 30 minutes, the initialization routine 124 may, in some embodiments, request additional information such as whether the user's back problems are upper back or lower back, and/or the type of repetitious movement injury that was sustained, and/or whether such injuries/problems are still affecting the user. It is intended that steps 1316 and 1320 be representative of such interactivity.

After this initial user collection of user recommended settings is obtained, in step 1324, the worksite computer 78 transfers the resulting ergonomic information, via the network 86, to the administration subsystem 54.

Depending on the embodiment of the present invention, the worksite subsystem 74 will contact the administrative computer 58 for at least storing in the settings and history database 100 user ergonomic settings and/or ranges agreed on by the user and the ergonomic expert.

The invention also includes other embodiments for initiating or registering the user at the worksite 60. Accordingly, network 86 communications between the worksite subsystem 74 and the administration subsystem 54 may be performed in one of the following ways:
(9.1) immediately after the user's recommended settings have been input to the initialization routine 124,
(9.2) after all or most of the ergonomic settings and ranges for the user have been determined, or
(9.3) prior to the user's physical characteristics being input to the initialization routine 124.
   In (i) immediately above, the initialization routine 124 includes programmatic elements and data for capturing the user's physical characteristics. In (ii) immediately above, the initialization routine 124 includes additional functionality wherein recommended ergonomic settings and ranges can be determined without interactive communications with the administration subsystem 54 during the determination process. In (iii) immediately above, the initialization routine 124 may rely substantially on the functionality of the administration subsystem 54 to assist the user and/or the ergonomic expert in determining the user's ergonomic settings and ranges. Note that (iii) may be particularly preferred if the functionality for determining the ergonomic settings and ranges for the user are propriety, or are provided in combination with teaching presentations related to ergonomics of the worksite and the furniture units 90 therein. Further note that in any of the communication techniques between the worksite computer 78 and the administrative computer 58 such as (9.1) through (9.3) above, the network communications may be based on a client-server network communication model, or on a more peer-to-peer interactive model, or a hybrid of these models.

However, note that in most embodiments of the invention, it is expected that the proper ergonomic settings for a user will require an ergonomic expert to thereby remove liability from decisions made solely by the user interacting with the intelligent agent or wizards that may be provided by the present invention.

Regardless of whether steps 1312 through 1324 are performed (i.e., whether the user is a new user or a previously identified user), step 1328 is performed wherein the user's ergonomic settings for the furniture unit(s) 90 at the worksite 60 are retrieved from the database 100 and provided to the worksite subsystem 74. That is, the determined/retrieved the user settings for the computer adjustable furniture unit(s) 90 (e.g., a work table and any adjustable keyboard support settings) at the worksite 60 are provided (e.g., via the network 86) to the initialization routine 124 at the user's worksite computer 78. In one embodiment, so as not to alienate the user, the initialization routine 124 presents the determined ergonomic settings to the user, and then requests that the user enter his/her assent to “try out” these settings, such as, the worksite table height determined to be the most appropriated ergonomic height for the user and optionally the determined keyboard support height. Moreover, such “try outs” may include other adjustments if the table and/or other adjustable furniture 90 is provided at the worksite 60. Thus, for a table having a computer adjustable tilt, one or more tilt angles may be determined for “try out”. However for table tilt, it is important that any recommended tilt be appropriate to the task being performed by the user. Thus, although a non-horizontal tilt may be very beneficial to a sketch artist, draftsperson or radio sound person, such a tilt may be wholly inappropriate for the desk of a legal secretary.

Note, that there may be a number of such “try outs” of heights, tilts, etc. For example, the user may first request a “try out” of a table height for sitting at the table. Subsequently, the user may request a “try out” of a table height for standing at the table. Moreover, the initialization routine 124 may present to the user a schedule for periodically varying the table height, e.g., between sitting and standing positions for the user so that the control system 50 can receive any initial feedback from the user regarding the appropriateness and/or desirability of such a schedule as well as the determined table settings.

Subsequently, the flow of control returns to FIG. 2 described hereinabove.

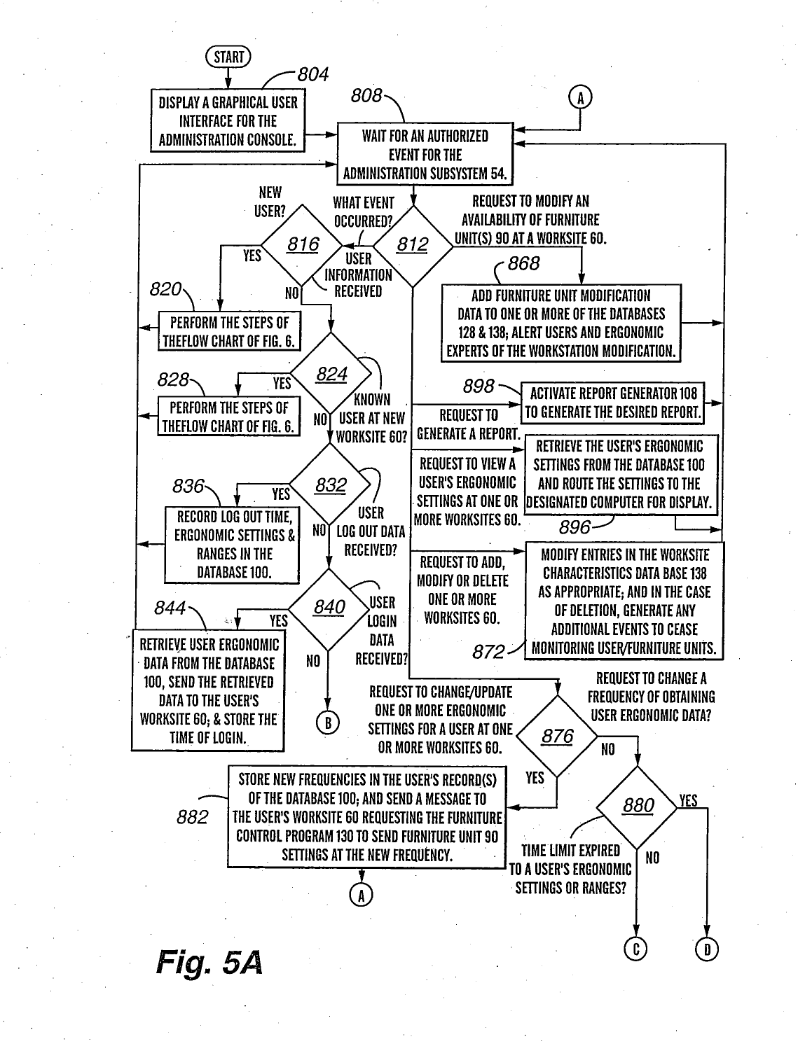

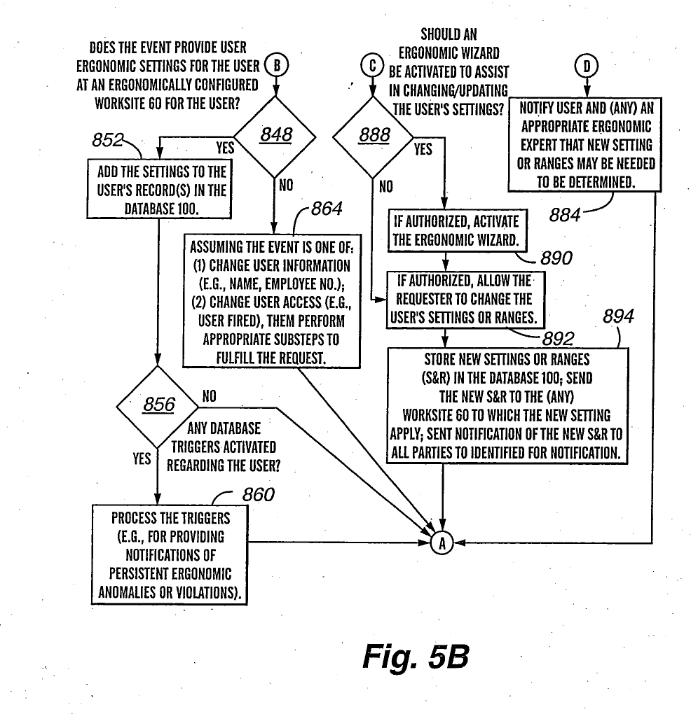

FIG. 5 shows a high level flowchart of the steps performed by the administration subsystem 54 when an operator is interacting with this subsystem to generate reports and/or review/edit worksite user ergonomic settings. Subsequent to initialization of the administration subsystem 54 (in step 804), a graphical user interface for this subsystem is displayed on a computer display (not shown) that is operably connected to the ergonomic administrative computer 58. In particular, this user interface provides an operator with access to substantially all functions provided by the administration subsystem 54, this interface referred to as a “console” herein. Subsequently, in step 808, the administration subsystem 54, and more particularly, an event classifier module (not shown), waits for an authorized event to be provided to the subsystem. The term “authorized events” should be interpreted here as referring to any input or event filtering or classification process(es) that can be used to determine the appropriateness or legitimacy of an input to the administration subsystem 54. Accordingly, the present invention includes (or alternatively, operably communicates with) various authorization processes such as: a login identification of an operator or ergonomic expert, a network firewall for accessing the ergonomic administrative computer 58, Internet “cookie” data, or business entity identification data.

Upon receipt of a presumably authorized or legitimate event (in step 812) the event classifier module determines how the event is to be processed and what modules of the administration subsystem 54 are to be activated for such processing. In the present embodiment, the following events are processed by the administration subsystem 54:
(10.1) An event providing user information such as for registering a new user at one or more worksites 60, for registering a current user at a new worksite 60, for recording ergonomic settings, login or logout data of a user at a known worksite 60.
(10.2) An event requesting to modify the availability of one or more furniture units 90 at a known worksite 60 (e.g., a new computer adjustable furniture unit 90 may be added to a worksite 60; an existing worksite furniture unit 90 may be malfunctioning, or moved out of the existing worksite).
(10.3) An event requesting to: (i) add one or more worksites 60 to the collection of worksites whose adjustable furniture unit settings are to be tracked/logged, or (ii) modify or delete one or more worksites 60 known to the administration subsystem 54 (e.g., such a modification request may be for identifying the worksite 60 at different location such as occurs with an office move).
(10.4) An event to change or update one or more ergonomic settings for one or more furniture units 90 for a particular user at a specified one or more worksites 60 (e.g., change a computer adjustable table height, change the inflation of various compartments of a computer adjustable chair, vehicle seat, or machinery operation seat).
(10.5) An event to retrieve or access a user's ergonomic settings for one or more furniture units 90 at one or more worksites 60 (e.g., a user may wish to view such settings for all furniture units 90 and all worksites 60 where the user is registered for ergonomic assistance and tracking by the present invention.
(10.6) An event requesting that a report be generated providing, e.g., one or more of: (i) the ergonomic settings for one or more users at one or more worksites 60; (ii) the frequency and/or amount of time that a user deviates from a prescribed furniture unit 90 setting(s); (iii) statistics related to user physical condition improvement (or the lack thereof) that coincides with following prescribed furniture unit 90 settings; and (iv) a variation in furniture unit 90 setting ranges over a group of users having the same user physical condition (e.g., lower back discomfort).

Regarding (10.1) above, in step 816 a determination is made as to whether the event data received is for a registering a new user. If so, then step 820 is performed wherein the flowchart of FIG. 4 is performed for registering the user with the administration subsystem 54. Note that FIG. 4 is described hereinabove. Subsequently once the new user is registered (or registration is declined), step 808 is again performed. Alternatively, if the user is already registered with the administration subsystem 54, then step 824 is performed wherein a determination is made as to whether the event data relates to the user being at a new worksite 60. Thus, if the known user is at a worksite known to the administration subsystem 54 but worksite has not been ergonomically configured for the user, then step 828 is performed wherein a registration of the user at the new worksite 60 is performed. In particular, note that such user worksite registration can rely on previously obtained information regarding both the user and this worksite. Thus, for a particular type of furniture unit(s) 90 (at the new worksite 60) for which the user already has prescribed settings from another or previous worksite 60, such settings may be automatically carried over to the corresponding furniture types of the new worksite. Accordingly, only furniture units 90 at the new worksite 60 that do not correspond with furniture units at a previous worksite may need to be calibrated to the user. Subsequently, once step 828 is performed, step 808 is again performed.

If it is determined in step 824 that the event data is for a registered user that is not at a new worksite 60, then in step 832 a determination is made as to whether the event data identifies that a user has logged out from a (known) worksite computer 78. If so, then in step 836 the log out time, and the furniture unit 90 setting(s) at the time of the user's log out are written into the user's records of the database 100, and step 808 is subsequently performed.

Alternatively, if the user has not logged out, then in step 840 a determination is made as to whether the received event identifies a login of a registered user at a known worksite computer 78. If so, then in step 844, the event data is parsed for obtaining the user's identity, the user's login time, and the identity of the worksite 60 from which the user logged in. The user's identity is used to retrieve furniture unit 90 ergonomic settings (and in the case of the present invention being used as part of a subscription service, the user's identity can be used to determine whether the user is still legible to utilize the present invention) from the ergonomic settings and history database 100. The data identifying the worksite 60 is used to retrieve information on the (any) furniture unit(s) 90 that are available for use at the identified worksite (e.g., by accessing the worksite characteristics database 138 for the identified worksite 60). Thus, using these retrieved data, the most recent furniture settings for the user at the identified worksite 60 can be determined and transmitted to the worksite computer 78. Note, that in one embodiment, the databases 100, 128, and 138 may be part of a single database. Moreover, if this single database has a relational in architecture, then various relational join operations may be used to retrieve the desired furniture settings as one skilled in the art will understand.

If the result from step 840 indicates that the present event does not identify the occurrence of a user logging in at a worksite 60, then a further determination is made (in step 848) as to whether the event provides the current settings for the furniture unit(s) 90 at the worksite 60. If so, then in step 852 these current settings are added to the user's record(s) in the database 100 (in particular, such settings are added to the usage data table of (2.2) described above). Subsequently, in step 856, a determination is made as to whether the adding of the new furniture unit(s) 90 settings activates any database triggers (e.g., data driven processes that are automatically activated due to changes in the user's data in the database 100). Note, that zero or more triggers may be provided depending on the embodiment of the invention. Triggers may be provided for:
(11.1) Contacting the user's supervisor and/or an ergonomic expert when there are a sufficient number of violations of prescribed ergonomic settings.
(11.2) Alerting the user that the current settings are outside of his/her prescribed ergonomic settings.
(11.3) Settings for one or more furniture units 90 where these settings have expired and require re evaluation.
(11.4) Recording (and/or notifying the user or other responsible parties of) the time a user remains at a particular position or setting wherein this time has exceeded the recommended duration and thus a change to the user's position is required/preferred to occur.

If such triggers are provided, then they are processed or activated in step 860. In particular, such triggers may be provided that statistically analyze the user's recent ergonomic settings to determine if violations of ergonomic settings are of sufficient frequency and/or duration to warrant notification of one or more parties identified in the user's records of the database 100. Subsequently, step 808 is again performed.

Alternatively, if step 848 yields a negative result, then the present event is likely to be for changing user identifying information and/or changing a user's ability to use the administration subsystem 54. Accordingly, in step 864 the appropriate substeps are performed to fulfill the request, and subsequently step 808 is again performed.

Regarding (10.2) above, in step 868 the following substeps are performed for adding a new furniture unit 90 to a worksite:
(12.1) If a new furniture unit 90 is requested to added to a worksite 60, then the following information is obtained and entered into the furniture unit database 128: (i) the identification of the furniture unit (i.e., the type of furniture unit, the make and model, and serial number), (ii) a description of the new furniture unit, (iii) links or data indicative of any known ergonomic calibrations of the furniture unit, and (iv) the location of the furniture unit (note, this may be optional in that this data may be stored in the worksite characteristics database 138).
(12.2) Alerts or triggers are generated for each user that uses the worksite so that he/she can be alerted that the new furniture unit 90 may have to be ergonomically configured to the user. Note that such alerts can be in the form of email, and/or notifications provided by the ergonomic control system 50 when the user is next logged on at the worksite.
(12.3) Additionally, alerts may be transmitted to ergonomic experts responsible for the worksite 60 and/or one or more users at the worksite. Note that such alerts can be in the form of email, and/or notifications provided by the ergonomic control system 50 when the expert is next logged on to the administration subsystem 54.

Regarding (10.2) above, in step 868 the following substeps are performed for removing a furniture unit 90 from a worksite:
(13.1) Using the furniture unit 90 identification (likely provided with the event to remove the furniture unit), if the furniture unit is no longer going to be used, then the data for the furniture unit in the furniture unit database 128 is deleted (and optionally archived); if the furniture unit may be subsequently used, then the data in the furniture unit database is flagged as not currently in use.
(13.2) The location of the furniture unit 90 (in the database 128 or the database 138) is one of: deleted, overwritten with a new location for the furniture unit, or marked to indicate that the current location data is invalid.
(13.3) The settings monitor module 112 is requested to no longer monitor user ergonomic settings of the furniture unit 90.
(13.4) User records in the database 100 may be modified for those users that were using the furniture unit so that there is at least a description of why there will be no further entries for this furniture unit.
(13.5) Database 100 triggers and alerts that are driven from ergonomic tracking from the furniture unit are inactivated (note this may be performed by the settings monitor module 112.
(13.6) Both the user(s) of the furniture unit 90 being removed, and the responsible ergonomic experts may be alerted as in (12.2) and (12.3) above.

Regarding (10.2) above, in step 868 the following substeps are performed for identifying a furniture unit 90 as malfunctioning at a worksite:
(14.1) Using the furniture unit 90 identification (likely provided with the event identifying the malfunctioning furniture unit), if the furniture unit is no longer going to be used, then the data for the furniture unit in the furniture unit database 128 is deleted (and optionally archived); if the furniture unit may be subsequently used, then the data in the furniture unit database is flagged as not currently in use.
(14.2) The settings monitor module 112 is requested to no longer monitor user ergonomic settings of the furniture unit 90.
(14.3) User records in the database 100 may be modified for those users that were using the furniture unit so that there is at least a description indicating that the furniture unit is malfunctioning.
(14.4) Database 100 triggers and alerts that are driven from ergonomic tracking from the furniture unit are inactivated (note this may be performed by the settings monitor module 112.
(14.5) Both the user(s) of the furniture unit 90 that is malfunctioning, and the responsible ergonomic experts may be alerted as in (12.2) and (12.3) above.

Regarding (10.3) above, in step 872, the following substep(s) are performed for adding a new worksite 60:
(15.1) A new entry is created in the worksite characteristics database 138 having the data of (4.1) through (4.6) above. Note that the data for populating this new worksite 60 entry is provided in one or more “new worksite” events generated by, e.g., an operator of the administration subsystem 54, or an administrative manager for a subscriber having access to a service that utilizes embodiment of the ergonomic control system 50 of the present invention.

Regarding (10.3) above, in step 872, the following substep(s) are performed for deleting or inactivating a worksite 60:
(16.1) Generate additional events requesting the cessation of monitoring user's ergonomic settings at the worksite 60.
(16.2) Generate additional events to cease monitoring any furniture unit(s) 90 at the worksite.
(16.3) Remove or inactivate entries identifying the worksite in the worksite characteristics database 138.
(16.4) Notify any user(s) of the worksite that they no longer have access to the ergonomic control system 50 from the worksite.

Regarding (10.3) above, in step 872, the following substep(s) are performed for modifying data for a known worksite 60:
(17.1) Events for modifying worksite data are for changing one or more of the items of (4.1) through (4.6) above. Accordingly, the worksite characteristics database 138 is accessed with an identifier (supplied by the event invoking this activity) for the worksite and the worksite data to be modified.

Regarding (10.4) above, in step 876, a determination is made as to whether the event includes a request to change, for an identified user, a frequency of obtaining ergonomic data from one or more furniture units 90 at a worksite 60. If request to change the monitoring frequency for one or more furniture units 90 is obtained, then in step 880 the new monitoring frequency (or frequencies) is entered into the user's records in the database 100, and a message is transmitted to the user's worksite having the identified furniture units for requesting the furniture control program 130 at the worksite to send the settings of the identified unit(s) 90 at the new frequency (or frequencies). Subsequently, the flow of control returns to step 808.

Alternatively, if the determination in step 876 is negative, then in step 884 a further determination is made as to whether a time limit has expired on monitoring an identified user's ergonomic settings or ranges. Note that such expiration may be, e.g., due to: (i) the expected termination of a user's physical condition (e.g., pregnancy), (ii) a “try out” period for certain ergonomic settings expiring, (iii) a known date for the move of the user to another worksite 60, etc. In any case, if the determination of step 884 is that such a time limit has expired, then in step 888 the identified user and (any) ergonomic expert are notified that new ergonomic settings may need to be provided for the furniture unit(s) 90 corresponding to the event presently being processed. Note that in one embodiment of the invention, user settings (in the database 100) having such expiration dates associated therewith may have corresponding default settings that are activated when no other settings are available. Subsequently, the flow of control returns to step 808.

If the determination of step 880 is that no time has expired, then it is assumed that for an identified user, there are one or more furniture units 90 whose ergonomic settings are being requested to be changed. Accordingly, in step 888 a determination is as to whether the event being processed is a request to activate an ergonomic intelligent program or wizard to assist in changing or updating a user's ergonomic settings. If so, then in step 890 such a wizard may be activated. However, such activation may require the user to authorized in that, e.g., the wizard may be designed to interact with ergonomic experts.

Regardless of the outcome of the determination in step 888, step 892 is ultimately performed wherein a determination of whether the initiator of the event being processed is authorized to change the identified user's ergonomic settings. If so, then the new settings provided by the event initiator are used to generate an additional event to be processed by the user initialization module 94 to change the user's settings in the database 100. Thus, in step 894 the user's settings are changed in the database 100, a notification of the change is sent to the worksite 60 having the one or more furniture units 90, and notifications of the new setting are sent to all parties identified for notification in the user's records of the database 100. Subsequently, the flow of control returns to step 808.

Regarding (10.5) above for viewing a user's ergonomic settings, step 896 is performed wherein the identified user's ergonomic settings are retrieved from the database 100. Note that such settings may be retrieved according to various conditions such as: (i) the user's current (or past) settings at an identified worksite 60; (ii) the user's current (or past) settings for an identified furniture unit 90; (iii) the settings that are expected to expire within an identified time frame; and/or (iv) the user's current (or past) settings at all worksites 60 at which the user is registered with the ergonomic control system 50. Subsequently, the flow of control returns to step 808.

Regarding (10.6) above for requesting a report, step 898 is performed wherein the report generator 108 is activated to generated the desired report, assuming of course that the event initiator has appropriate authorization to have the desired report generated. Subsequently, the flow of control returns to step 808.

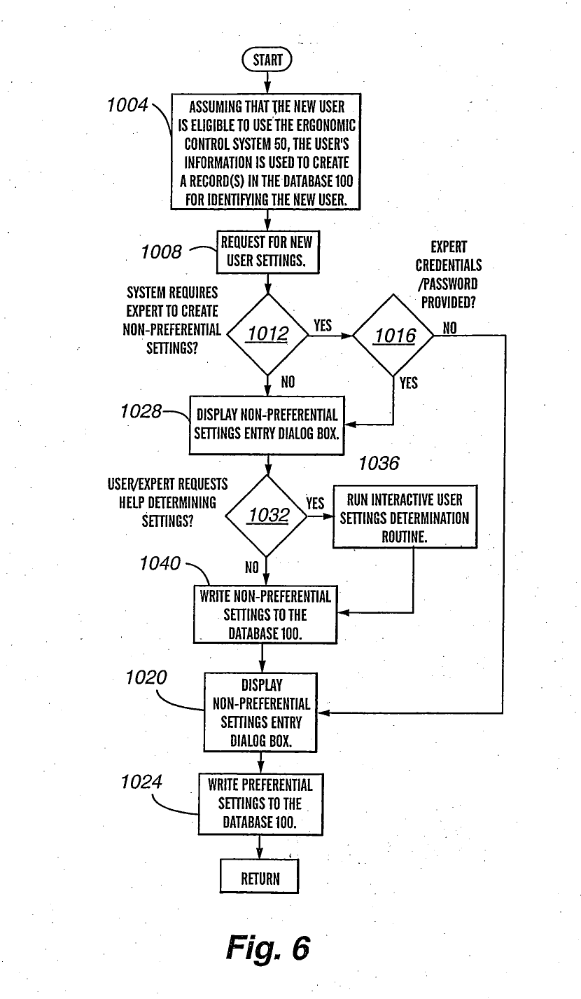

FIG. 6 will now be described. This flowchart is an embodiment of some of the high level steps performed for registering a new user with the administration subsystem 54, and in particular, for obtaining ergonomic settings for one or more furniture units 90 at least one worksite 60. Note that these steps are performed by the user initialization module 94. Moreover, some of the steps of FIG. 6 may require further network 86 communications with the user or an ergonomic expert; thus, it may be necessary to process additional events by the event classifier of the administration subsystem 54. Accordingly, steps 812 and 816 may be iteratively performed in various steps FIG. 6 as one skilled in the art will understand. Accordingly, it is to be understood that any communication or response from the worksite 60, the user or the ergonomic expert in the description of the steps of FIG. 6 hereinbelow will generate an additional “new user information” event to be processed by the event classifier and thus result in the performance of steps 812 and 816. Such details will not, in general, be elaborated on further in describing the steps of FIG. 6.

Assuming the new user event (received from the event classifier module of the administration subsystem 54) includes new user information that identifies a user eligible to use the ergonomic control system 50, in step 1004, the user's identification information is used to create one or more records in the database 100 for identifying the new user. Note that in one embodiment, at least the data tables of (2.1) through (2.3) are created and user information for (2.1) (i) and (2.1) (ii) may be entered into the database 100. Subsequently, in step 1008, a request for ergonomic settings for the new user may be requested. Note that this step corresponds to an embodiment of the technique of (9.3) above. However, one skilled in the art will understand that the present flowchart (as well other processing by the administration subsystem 54) can be modified to conform to (9.1) or (9.2).

Once a responsive event is received from, e.g., a user or ergonomic expert, in step 1012, a determination is made as to whether these initial ergonomic settings received (denoted herein the “non-preferential settings”) must be supplied by an ergonomic expert. If so, then in step 1016 a determination is made as to whether the non-preferential settings were supplied by such an expert. In particular, a determination is made as to whether appropriate identification is supplied to verify the identity of the ergonomic expert. If no appropriate identification of an ergonomic expert is received, then step 1020 is performed wherein an entry dialog box is displayed to the initiator for obtaining ergonomic settings wherein predetermined “best-fit” ergonomic settings (denoted as “preferential settings” herein) for the furniture unit(s) 90 at the worksite 60 are presented to the initiator requesting initialization of the new user. In particular, these preferential settings may be displayed to the initiator in a “new user entry” dialog box. Subsequently, in step 1024, the preferential settings are written in the database 100 as the new user's initial ergonomic settings. In particular, the preferential settings written to the configuration data table of (2.3) described above. Note that such best-fit ergonomic settings default settings based on the new user information collected. However, it is preferred that when such non-expert settings are written to the database 100, that an ergonomic expert is also alerted of this situation so that the non-preferential settings for the new user can at least be reviewed.

Following step 1024, the flow of processing control returns to the step following step 820 of FIG. 5.

Alternatively, if there is a positive result in step 1016 thereby indicating that the non-preferential ergonomic settings were provided by an ergonomic expert, then in step 1028, these non-preferential settings are transmitted to the initiator (e.g., the ergonomic expert) and displayed in a in a “new user entry” dialog box. Additionally, note that step 1028 is also performed if it is determined in step 1012 that it is unnecessary for the non-preferential settings to be supplied by an ergonomic expert. Thus, with the performance of step 1028 it is assumed that the non-preferential settings are legitimate entries by the initiator.

Subsequently, in step 1032, a determination is made as to whether the initiator (e.g., the user or the ergonomic expert) requests additional assistance in determining, reviewing, and/or assessing the non-preferential settings. If so, then in step 1036, an interactive ergonomic settings determination routine(s) is activated. Note that such a routine(s) may be classified as a “wizard” in the computer arts; i.e., the routine(s) may include substantial programmatic ergonomic knowledge for suggesting ergonomic settings for various furniture units 90 such as computer adjustable tables, computer adjustable chairs, as well as other such furniture units mentioned hereinabove. In particular, such routine(s) may do more than merely output a precalibrated ergonomic value (or range of values) for a furniture unit that is dependent upon a single user physical characteristic. Instead, the routine(s) may perform a statistical analysis of ergonomic settings previously used by other users wherein the settings were considered effective in facilitating user health and/or efficiency. Additionally, in another embodiment, the routine(s) may contact an ergonomic expert for providing further expert advice.

Regardless of the outcome from step 1032, in step 1040, the non-preferential settings are written to the database 100 as part of the configuration data table of (2.3). Note that the non-preferential setting data written in step 1040 may be the result of any interactions with the wizard(s) activated in step 1036. In one embodiment, both the initial non-preferential settings and the analysis output by the wizard(s) in step 1036 may be written to the database 100. Moreover, note that by the time step 1040 is performed, the preferential settings will have been determined (i.e., via step 1036, or if step 1036 is not performed, then by using the non-preferential settings as the preferential settings). Thus, in the next performed step (1020), these preferential settings output to the initiator for his/her consent or verification. Subsequently, assuming a response indicative of such consent or verification is received, the preferential settings are to the new user's record(s) in the database 100, and the flow of control returns to FIG. 5.

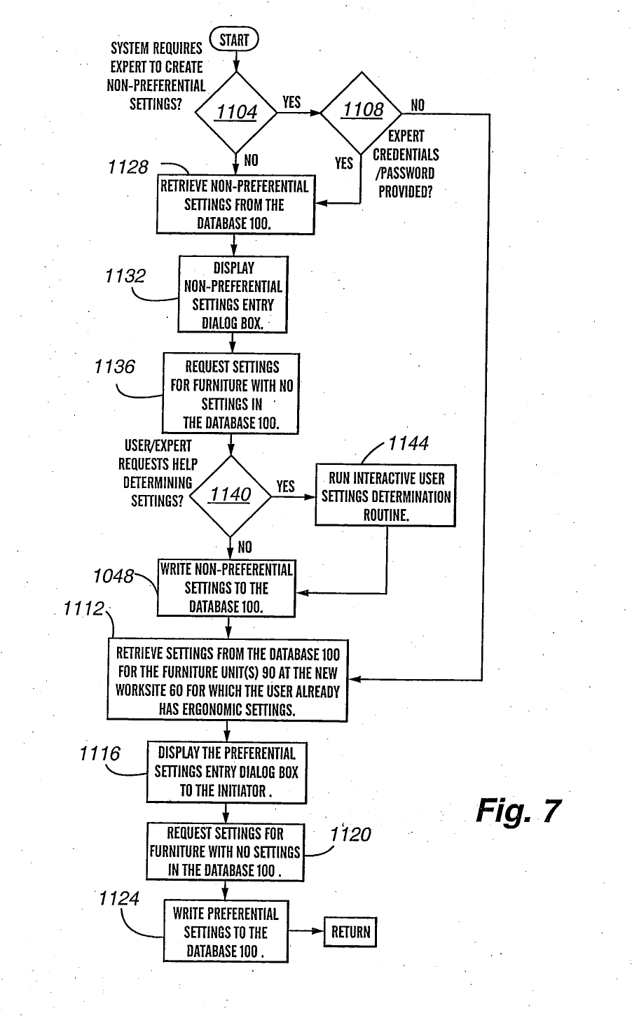

FIG. 7 will now be described. This flowchart is an embodiment of some of the high level steps performed for configuring ergonomic settings of a current user at a new worksite 60, and in particular, for obtaining ergonomic settings for one or more furniture units 90 for the new worksite 60. Note that these steps are performed by the user initialization module 94. Moreover, some of the steps of FIG. 7 may require further network 86 communications with the user or an ergonomic expert; thus, as with FIG. 6, it may be necessary to process additional events by the event classifier of the administration subsystem 54. Accordingly, steps 812 and 816 may be iteratively performed in various steps FIG. 7 as one skilled in the art will understand. Accordingly, it is to be understood that any communication or response from the worksite 60, the user or the ergonomic expert in the description of the steps of FIG. 7 hereinbelow will generate an additional “user information” event to be processed by the event classifier and thus result in the performance of steps 812 and 816. Such details will not, in general, be elaborated on further in describing the steps of FIG. 7.

Once a responsive event is received from, e.g., a user or ergonomic expert regarding the configuring of a new worksite 60 for the user, in step 1104, a determination is made as to whether these initial ergonomic settings received (denoted herein the “non-preferential settings”) must be supplied by an ergonomic expert. If so, then in step 1108 a determination is made as to whether the non-preferential settings were supplied by such an expert. In particular, a determination is made as to whether appropriate identification is supplied to verify the identity of the ergonomic expert. If no appropriate identification of an ergonomic expert is received, then step 1112 the ergonomic settings are retrieved from the database 100 for the furniture unit(s) 90 for which the user already has current ergonomic settings. Subsequently, in step 1116, an ergonomic settings entry dialog box is displayed to the initiator for: (i) displaying the current furniture unit 90 settings for those furniture unit(s) at the new worksite 60 for which the user has settings current settings in the database 100, and (ii) obtaining ergonomic settings for any other furniture unit(s) 90 at the new worksite. In particular, the furniture unit 90 settings that are currently available for use will be identified in the ergonomic settings entry dialog box as the preferred or “preferential settings”. Subsequently, assuming there is at least one furniture unit 90 at the new worksite 60 for which the user does not have a current ergonomic setting(s) in the database 100, then in step 1120 a request transmitted to the initiator to provide ergonomic settings for this at least one furniture unit 90 at the new worksite 60. Note that in some embodiments there may be a single transmittal to the initiator for both steps 1116 and 1120. Subsequently, assuming the initiator supplies such settings for the at least one furniture unit 90, these settings are stored in the database 100. However, since these settings are not from an identified ergonomic expert (i.e., due to the negative result from step 1108), these setting are not used. Instead, in step 1124, “best-fit” ergonomic settings (denoted as “preferential settings”) for the at least one furniture unit 90 at the new worksite 60 are presented to the initiator requesting the configuration of the furniture unit(s) 90 at a new worksite 60 for the user. Moreover, these preferential settings are also written to the database 100 as part of the user's records. In particular, the preferential settings written to the configuration data table of (2.3) described above. Note that such best-fit ergonomic settings default settings are based on user information collected. However, it is preferred that when such non-expert settings are written to the database 100, that an ergonomic expert is also alerted of this situation so that the non-preferential settings for the user can at least be reviewed. Moreover, if the initiator is the user, then step 1120 may further attempt to obtain the user's assent to at least, “try out” the preferential settings. Such assent and/or non-assent will also be recorded in the database 100.

Following step 1124, the flow of processing control returns to the step following step 828 of FIG. 5.

Alternatively, if there is a positive result in step 1108 thereby indicating that the initiator is an authorized ergonomic expert, then in step 1128, any previously non-preferential settings (i.e., settings that have not as yet been authorized for use) for a furniture unit(s) at the new worksite 60 that are stored in the database 100 are transmitted to the initiator (e.g., the ergonomic expert). Additionally, note that step 1128 is also performed if it is determined in step 1104 that it is unnecessary for the non-preferential settings to be supplied by an ergonomic expert. Thus, with the performance of step 1128, it is assumed that the non-preferential settings are sufficiently legitimate entries so that in step 1132 these non-preferential settings can be displayed to the initiator in a in an ergonomic settings entry dialog box. Subsequently, in step 1136, the initiator is presented with a request for the initiator to provide ergonomic settings for the furniture unit(s) 90 at the new worksite 60 for which there is no useable settings available in the database 100.

Subsequently, in step 1140, a determination is made as to whether the initiator (e.g., the user or the ergonomic expert) requests additional assistance in determining, reviewing, and/or assessing the non-preferential settings and/or the newly input settings from step 1136. If so, then in step 1144, an interactive ergonomic settings determination routine(s) is activated. Note that such a routine(s) may be classified as a “wizard” in the computer arts; i.e., the routine(s) may include substantial programmatic ergonomic knowledge for suggesting ergonomic settings for various furniture units 90 such as computer adjustable tables, computer adjustable chairs, as well as other such furniture units mentioned hereinabove. In particular, such routine(s) may do more than merely output a precalibrated ergonomic value (or range of values) for a furniture unit that is dependent upon a single user physical characteristic. Instead, the routine(s) may perform a statistical analysis of ergonomic settings previously used by other users wherein the settings were considered effective in facilitating user health and/or efficiency. Additionally, in another embodiment, the routine(s) may contact an ergonomic expert for providing further expert advice.

Regardless of the outcome from step 1140, in step 1148, the non-preferential settings are written to the database 100 as part of the configuration data table of (2.3). Note that the non-preferential setting data written in step 1048 may be the result of any interactions with the wizard(s) activated in step 1144. In one embodiment, both the initial non-preferential settings and the analysis output by the wizard(s) in step 1144 may be written to the database 100. Moreover, note that by the time step 1148 is performed, the preferential settings (i.e., authorized ergonomic settings) will have been determined (i.e., via step 1144, or if step 1144 is not performed, then by using the non-preferential settings as the preferential settings). Thus, steps 1112 through 1124 are again performed. Subsequently, the flow of control returns to FIG. 5.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. An ergonomic control system, comprising:
a first worksite subsystem, operatively connected to one or more furniture units at a first worksite, for signally communicating with said furniture units;
wherein each of said furniture units is provided with signals from said first worksite subsystem for controlling at least one adjustable ergonomic characteristic of the furniture unit, and wherein said furniture unit outputs signals indicative of values of said adjustable ergonomic characteristic;
an administration subsystem for signally communicating with said first worksite subsystem via a communications network;
wherein said administration subsystem receives communications, via the network, from said first worksite subsystem, said communications providing ergonomic information including: (a1) first information indicative of a time series of settings for said at least one adjustable ergonomic characteristic of at least one of said furniture units at said first worksite, and (a2) an identification of a first user at said first worksite using said at least one furniture unit at times corresponding to said time series;
wherein said administration subsystem includes at least some of (b1) through (b5) the following:
(b1) a first programmatic element that compares said first information with one or more predetermined ergonomic settings for determining one of a consistency and a deviation;
(b2) a first data storage for storing data indicative of at least (a1) and (a2) above, wherein said data storage is accessible by a report generator for outputting second information derived from (a1) and (a2), said report generator accessing a portion of said first information according to a predetermined time period;
(b3) a second programmatic element that transmits, to the first worksite subsystem, a request to change a setting of the at least one adjustable ergonomic characteristic of a first of said one or more furniture units;
(b4) a third programmatic element that stores first data identifying the first worksite, and second data identifying at least a second worksite having a second worksite subsystem operably connected to one or more furniture units at said second worksite communicating ergonomic related information therebetween, said first and second worksite subsystems having interleaved communications with said administration subsystem while the first user is using one of the furniture units at the first worksite and the second user is using one of the furniture units at the second worksite;
(b5) a fourth programmatic element that interactively communicates with at least one of the first user and an ergonomic expert for determining one or more preferred settings of a first of the furniture units at the first worksite.

2. The ergonomic control system of claim 1, wherein at least one of said furniture units at the first worksite includes one of: a computer adjustable table, a computer adjustable chair, a computer adjustable keyboard, and computer adjustable worksite lighting.

3. The ergonomic control system of claim 1, wherein at least one of said furniture units at the first worksite includes one of: vehicle seat, a machinery operator seat, a bed, a massage device, and an exercise device.

4. The ergonomic control system of claim 1, wherein said administration subsystem transmits, to said first worksite subsystem, information indicative of one or more ergonomically preferred settings for the first user, wherein said ergonomically preferred settings are for at least one of the furniture units at said first worksite.

5. The ergonomic control system of claim 1, further including a settings selector, accessible by said administration subsystem, for obtaining new setting information from said first worksite subsystem, related to a change in a setting of one of the furniture units being used by the first user at the first worksite;
wherein said settings selector receives new preferred settings for the user, said new preferred settings provided to said first worksite subsystem.

6. The ergonomic control system of claim 1, wherein said administration subsystem includes (b1).

7. The ergonomic control system of claim 1, wherein said administration subsystem includes (b2).

8. The ergonomic control system of claim 1, wherein said administration subsystem includes (b3).

9. The ergonomic control system of claim 1, wherein said administration subsystem includes (b4).

10. The ergonomic control system of claim 1, wherein said administration subsystem includes (b5).

11. The ergonomic control system of claim 1, wherein said administration subsystem includes at least most of (b1) through (b5).

12. The ergonomic control system of claim 11, wherein said administration subsystem includes at least all of (b1) through (b5).

13. An ergonomic control system, comprising:
an administration system for communicating with a first worksite system via a communications network, and with a second worksite system via the communications network;
wherein the first worksite system communicates ergonomic related data with one or more furniture units at a first worksite;
wherein the second worksite system communicates ergonomic related data with one or more furniture units at a second worksite different from the first worksite;
wherein said administration subsystem receives communications, via the network, from said first and second worksite systems, said communications providing ergonomic information including: (a1) first information indicative of a first time series of setting for at least one adjustable ergonomic characteristic of at least a first said furniture unit at the first worksite, (a2) an identification of a first user at said first worksite using said first furniture unit at times identified in said first time series; (a3) second information indicative of a second time series of setting for said at least a second adjustable ergonomic characteristic of at least a second said furniture unit at the second worksite, and (a4) an identification of a second user at said second worksite using said second furniture unit at times identified in said second time series;
wherein said administration system includes at least some of (b1) through (b5) the following:
(b1) a first programmatic element that compares said first information with one or more predetermined ergonomic settings for determining one of a consistency and a deviation;
(b2) a first data storage for storing data indicative of at least (a1) and (a2) above, wherein said data storage is accessible by a report generator for outputting second information derived from (a1) and (a2), said report generator accessing a portion of said first information according to a predetermined time period;
(b3) a second programmatic element that transmits, to the first worksite subsystem, a request to change a setting of the at least one adjustable ergonomic characteristic of a first of said one or more furniture units;
(b4) a third programmatic element that stores first data identifying the first worksite, and second data identifying at least a second worksite having a second worksite subsystem operably connected to one or more furniture units at said second worksite communicating ergonomic related information therebetween, said first and second worksite subsystems having interleaved communications with said administration subsystem while the first user is using one of the furniture units at the first worksite and the second user is using one of the furniture units at the second worksite;
(b5) a fourth programmatic element that interactively communicates with at least one of the first user and an ergonomic expert for determining one or more preferred settings of a first of the furniture units at the first worksite.

14. The ergonomic control system of claim 13, wherein said administration subsystem includes (b1).

15. The ergonomic control system of claim 13, wherein said administration subsystem includes (b2).

16. The ergonomic control system of claim 13, wherein said administration subsystem includes (b3).

17. The ergonomic control system of claim 13, wherein said administration subsystem includes (b4).

18. The ergonomic control system of claim 13, wherein said administration subsystem includes (b5).

19. The ergonomic control system of claim 13, wherein said administration subsystem includes at least most of (b1) through (b5).

20. The ergonomic control system of claim 19, wherein said administration subsystem includes at least all of (b1) through (b5).

21. A method for distributing ergonomic information, comprising:
receiving communications, via a network, from a first system at a first worksite, and from a second system at a second worksite, wherein said first and second systems are identified as different nodes of the network, and wherein said communications provide ergonomic information including: (a1) first information indicative of a first time series of setting for at least one adjustable ergonomic characteristic of at least a first furniture unit at the first worksite, (a2) an identification of a first user at said first worksite using said first furniture unit at times identified in said first time series; (a3) second information indicative of a second time series of setting for at least a second adjustable ergonomic characteristic of at least a second furniture unit at the second worksite, and (a4) an identification of a second user at said second worksite using said second furniture unit at times identified in said second time series;
first determining, using said first information, a first result indicative of one of a consistency and a deviation from a first preferred ergonomic setting for the first furniture unit;
alerting at least one predetermined person of said first result;
second determining, using said second information, a second result indicative of one of a consistency and a deviation from a second preferred ergonomic setting for the second furniture unit;
alerting at least one predetermined person of said second result.

22. An ergonomic control system, comprising:
a worksite system, operatively connected to one or more furniture units at a worksite, for signally communicating with said furniture units;
wherein each of said furniture units is provided with signals from said worksite system for controlling at least one adjustable ergonomic characteristic of the furniture unit, and wherein said furniture unit outputs signals to said worksite system indicative of values of said adjustable ergonomic characteristic;
wherein said worksite system communicates, via a communications network, with an administration system having a different network address from the said worksite system, wherein said administration system receives, from said first worksite subsystem, communications providing ergonomic information including: (a1) first information indicative of a time series of settings for said at least one adjustable ergonomic characteristic of at least one of said furniture units at said first worksite, and (a2) an identification of a first user at said first worksite using said at least one furniture unit at times corresponding to said time series;
wherein said worksite system receives network communications from the administration system providing preferred settings for at least one of the furniture units at the worksite, and said worksite system presents said preferred settings to the first user.

23. The ergonomic control system of claim 22, wherein said worksite system includes a control component for changing a physical characteristic of at least one furniture unit at the worksite.

24. The ergonomic control system of claim 22, wherein said worksite system includes a control component for varying, over time, a physical characteristic of at least one furniture unit at the worksite.

25. The ergonomic control system of claim 22, wherein at least one of said furniture units includes one of: a computer adjustable table, a computer adjustable chair, a computer adjustable keyboard, and computer adjustable worksite lighting.
